(19) United States
(12) Patent Application Publication
(10) Pub. No.: US 2026/0275903 A1
(43) Pub. Date: Sep. 17, 2026

(54) SURGE AVOIDANCE CONTROL DEVICE, INTERNAL COMBUSTION ENGINE SYSTEM, SURGE AVOIDANCE CONTROL METHOD, AND PROGRAM

(71) Applicant: KOMATSU LTD., Tokyo (JP)

(72) Inventors: Haruki Kaneko, Tokyo (JP); Akira Ito, Tokyo (JP); Shoon Okawara, Tokyo (JP)

(73) Assignee: KOMATSU LTD., Tokyo (JP)

(21) Appl. No.: 19/161,852

(22) PCT Filed: Mar. 1, 2024
(86) PCT No.: PCT/JP2024/007725

§ 371 Date: Sep. 3, 2025

(30) Foreign Application Priority Data
Mar. 8, 2023 (JP) 2023-035518

(51) Int. Cl. F02B 37/22; F02D 41/00; F02D 41/38

(52) U.S. Cl. CPC F02B 37/22; F02D 41/0007; F02D 41/38; F02D 2200/0404; F02D 2200/0614; F02D 2200/101

(57) ABSTRACT

A surge avoidance control device that performs control, over an internal combustion engine including an internal combustion engine body and an exhaust turbine supercharger, to avoid a surge that occurs in the exhaust turbine supercharger, the surge avoidance control device: including a state transition determination unit that determines whether a state of the internal combustion engine body has transitioned to a predetermined deceleration state in which a surge is estimated to occur in the exhaust turbine supercharger, and a flow rate control unit that controls, if the state transition determination unit determines that the state has transitioned to the predetermined deceleration state, a flow rate of an exhaust gas to be supplied to a turbine of the exhaust turbine supercharger to become a flow rate that reduces a rotation speed of the turbine.

### TECHNICAL FIELD

The present disclosure relates to a surge avoidance control device, an internal combustion engine system, a surge avoidance control method, and a program.

The present application claims priority based on Japanese Patent Application No. 2023-035518, filed on Mar. 8, 2023, the contents of which are incorporated herein by reference.

### BACKGROUND ART

FIG. 22 is a schematic block diagram illustrating an example of an engine 200 which is an internal combustion engine employing the exhaust turbine supercharging method and exhaust gas recirculation (hereinafter referred to as ‘EGR’) method. In the engine 200, an exhaust turbine supercharger 201 includes, for example, a turbine 211 such as a variable geometry turbo (VGT) having a regulation nozzle that regulates a flow velocity of exhaust gas used for rotation of the turbine 211, a compressor 213, and a shaft 212 that couples the turbine 211 and the compressor 213 to transmit a rotational driving force of the turbine 211 to the compressor 213.

When an exhaust gas discharged from the engine body 203 passes through the turbine-side exhaust passage 223 and flows into the turbine 211, the turbine 211 rotates, and the compressor 213 rotates in conjunction with the rotation of the turbine 211. The compressor 213 compresses air flowing in from an inlet-side intake passage 221, that is, an intake gas, by rotation, and discharges the compressed intake gas to the engine-body-side intake passage 222. The intake gas having passed through the engine-body-side intake passage 222 is cooled by an aftercooler 202 and taken into the engine body 203 after cooling. Meanwhile, part of the exhaust gas discharged from the engine body 203 flows into an EGR-side exhaust passage 231. The exhaust gas having passed through the EGR-side exhaust passage 231 is cooled by an EGR cooler 204 and taken into the engine body 203.

Assume that an operation of sudden deceleration is performed on the engine 200, which suddenly reduced the engine rotation speed of the engine body 203, for example. In this case, although the engine body 203 does not require much intake air, the turbine 211 and the compressor 213 continue to rotate at a high speed due to their own inertia, and thus the pressure of the intake gas present in the engine-body-side intake passage 222 increases. Due to this increased pressure, pulsation occurs in the intake gas flowing through the compressor 213, which can cause the exhaust turbine supercharger 201 to vibrate, that is, a phenomenon known as a surge.

Patent Literature 1 proposes the following technique to avoid a surge. That is, in the technique disclosed in Patent Literature 1, when the fuel injection amount becomes 0 (mg/stroke), the EGR valve 205 inserted into the EGR-side exhaust passage 231 is fully open, and the regulation nozzle of the turbine 211 is fully open. As a result, part of the intake gas passing through the engine-body-side intake passage 222 flows into the EGR-side exhaust passage 231 as illustrated in FIG. 23. The intake gas flowing into the EGR-side exhaust passage 231 passes through the EGR-side exhaust passage 231 in the direction opposite to the flow of the exhaust gas as in FIG. 22, then flows into the turbine 211 via the turbine-side exhaust passage 223, and flows out from the outlet-side exhaust passage 224.

This reduces the pressure of the intake gas present in the engine-body-side intake passage 222, helping to avoid a surge. FIG. 24 is a graph showing characteristics of the compressor 213, which is a so-called blower map or compressor map. In FIG. 24, the vertical axis represents the pressure ratio of the compressor 213, that is, the value of the outlet pressure/inlet pressure of the compressor 213, and the pressure ratio increases in the direction from the bottom to the top. The horizontal axis represents the normalized airflow rate through the compressor 213, that is, the intake gas flow rate, expressed in units of ‘kg/s (second)’, and the airflow rate increases from left to right.

Each of the ten curves indicated by reference numerals 300 to 309 is a line of a constant rotation speed and indicates characteristics of the compressor 213 when its rotation speeds are different constant speeds. The characteristic indicated by reference numeral 300 at the maximum value of the pressure ratio is a characteristic in the state where the rotation speed of the compressor 213 is the highest, and the rotation speed of the compressor 213 decreases in the order in which the maximum value of the pressure ratio decreases. Therefore, the characteristic indicated by reference numeral 309 is the characteristic of the compressor 213 at the lowest rotation speed. The line indicated by reference numeral 400, that is, the line expressed by connecting reference numerals 300 to 309 indicating 10 characteristics at the positions at which the airflow rate is the minimum value is called a surge line. When the compressor 213 operates in a region on the left side of the surge line 400, that is, a region where the curves indicated by reference numerals 300 to 309 do not exist, a surge occurs.

For example, assuming that, when the operation point at which the compressor 213 is operating is the position indicated by reference numeral 500, the above-described operation of sudden deceleration is performed on the engine 200, resulting in a sudden reduction in the engine rotation speed of the engine body 203. In this case, the operation point of the compressor 213 moves on the line indicated by reference numeral 501 in the direction of the arrow from the operation point 500 as the starting point, and when the operation point exceeds a surge line 400, a surge occurs. In contrast, if the technique disclosed in Patent Literature 1 is applied before the operation point exceeds the surge line 400, the EGR valve 205 and the regulation nozzle of the turbine 211 are fully open, which causes the airflow rate of the compressor 213 to increase. As a result, the direction in which the operation point of the compressor 213 advances changes to, for example, the direction of the arrow of reference numeral 502, and the operation point of the compressor 213 does not exceed the surge line 400, enabling a surge to be avoided.

### CITATION LIST

### Patent Literature

Patent Literature 1: WO 2011/108549

### SUMMARY OF INVENTION

### Technical Problem

Since the EGR-side exhaust passage 231 is provided in the engine 200 illustrated in FIGS. 22 and 23, that is, an internal combustion engine employing the EGR method, the engine can use a means for avoiding surges disclosed in Patent Literature 1. However, internal combustion engines that do not employ the EGR method have been used in recent years. Such internal combustion engines that do not employ the EGR method have a problem that they are not able to use a means for avoiding surges disclosed in Patent Literature 1.

The present disclosure has been made in view of the above circumstances, and an object thereof is to provide a surge avoidance control device, an internal combustion engine system, a surge avoidance control method, and a program that can avoid a surge even in an internal combustion engine that does not employ the EGR method.

### Solution to Problem

One aspect of the present disclosure is a surge avoidance control device, which performs control, over an internal combustion engine including an internal combustion engine body and an exhaust turbine supercharger, to avoid a surge that occurs in the exhaust turbine supercharger, and includes a state transition determination unit that determines whether a state of the internal combustion engine body has transitioned to a predetermined deceleration state in which a surge is estimated to occur in the exhaust turbine supercharger, and a flow rate control unit that controls, if the state transition determination unit determines that the state has transitioned to the predetermined deceleration state, a flow rate of an exhaust gas to be supplied to a turbine of the exhaust turbine supercharger to become a flow rate that reduces a rotation speed of the turbine.

### Advantageous Effects of Invention

According to the above aspect, even an internal combustion engine that does not employ the EGR method can avoid surges.

### BRIEF DESCRIPTION OF DRAWINGS

FIG. 1 is a schematic block diagram illustrating a configuration of an internal combustion engine system according to a first embodiment.

FIG. 2 is a diagram illustrating an example of a data format of a data table according to the first embodiment.

FIG. 3 is a diagram illustrating an example of a data format of a surge occurrence precondition table according to the first embodiment.

FIG. 4 is a diagram illustrating an example of a data format of a surge avoidance control start condition table according to the first embodiment.

FIG. 5 is a diagram illustrating an example of a data format of a surge avoidance control termination condition table according to the first embodiment.

FIG. 6 is a graph showing an example of exhaust throttle valve control data and bypass valve control data according to the first embodiment.

FIG. 7 is a diagram illustrating an example of a surge avoidance control flag according to the first embodiment.

FIG. 8 is a diagram illustrating an example of a change rate application flag according to the first embodiment.

FIG. 9 is a flowchart showing the flow of processing performed by a state transition determination unit according to the first embodiment.

FIG. 10 is a flowchart showing the flow of processing performed by a flow rate control unit according to the first embodiment.

FIG. 11 is a graph showing an example of characteristics of a compressor according to the first embodiment.

FIG. 12 is a diagram showing graphs comparing an example of a change when the internal combustion engine system according to the first embodiment is used with an example of a change when a general internal combustion engine system is used.

FIG. 13 is a schematic block diagram illustrating a configuration of an internal combustion engine system according to a second embodiment.

FIG. 14 is a graph showing an example of exhaust throttle valve control data and bypass valve control data according to the second embodiment.

FIG. 15 is a diagram showing graphs comparing an example of a change when the internal combustion engine system according to the second embodiment is used with an example of a change when a general internal combustion engine system is used.

FIG. 16 is a diagram showing graphs comparing an example of a change when another configuration example of the internal combustion engine system according to the second embodiment is used with an example of a change when a general internal combustion engine system is used.

FIG. 17 is a schematic block diagram illustrating a configuration of an internal combustion engine system according to a third embodiment.

FIG. 18 is a diagram illustrating the action of the internal combustion engine system according to the first embodiment and the action of the internal combustion engine system according to the third embodiment.

FIG. 19 is a schematic block diagram illustrating a configuration of an internal combustion engine system according to a fourth embodiment.

FIG. 20 is a flowchart showing the flow of processing performed by a fuel-injection-amount control unit according to the fourth embodiment.

FIG. 21 is a diagram illustrating the action of the internal combustion engine system according to the fourth embodiment.

FIG. 22 is a schematic block diagram (part 1) illustrating a configuration of a general internal combustion engine employing the exhaust turbine supercharging method and the EGR method.

FIG. 23 is a schematic block diagram (part 2) illustrating a configuration of a general internal combustion engine employing the exhaust turbine supercharging method and the EGR method.

FIG. 24 is a graph showing an example of characteristics of a compressor included in a general internal combustion engine employing the exhaust turbine supercharging method and the EGR method.

### DESCRIPTION OF EMBODIMENTS

Hereinafter, embodiments of the present disclosure will be described with reference to the drawings. Note that descriptions of the same or corresponding configurations in each of the drawings are appropriately omitted by assigning the same reference numerals thereto.

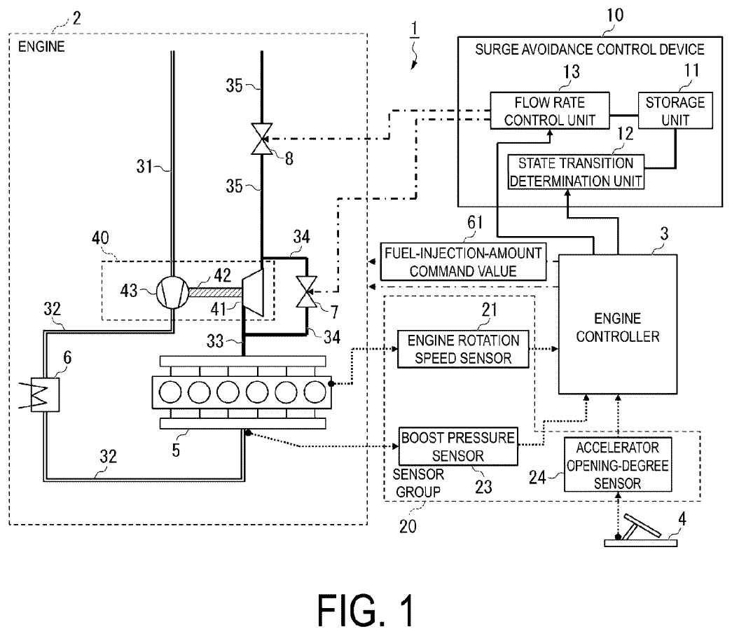

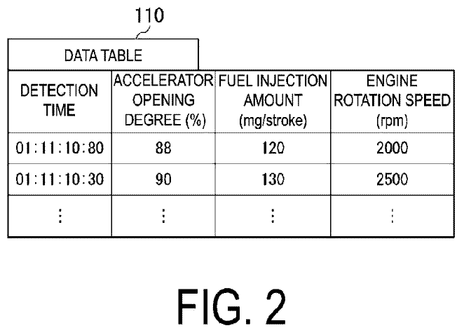

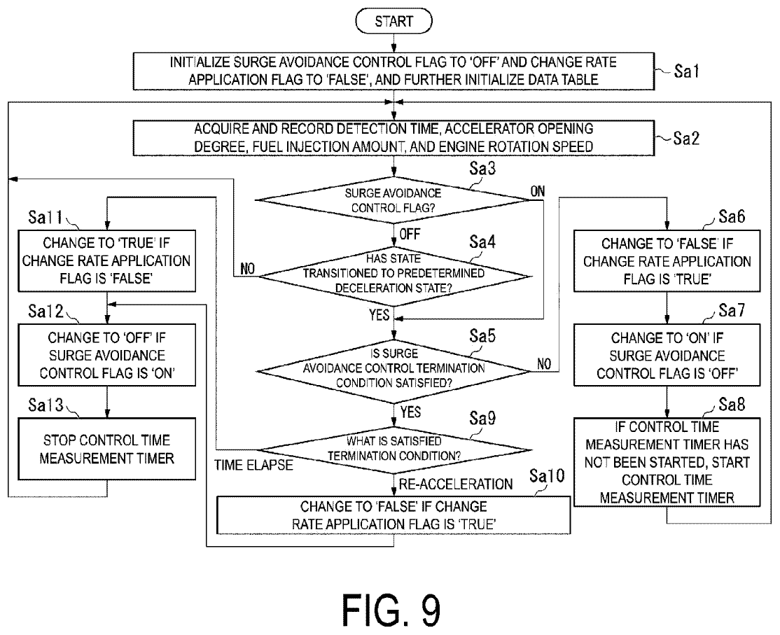

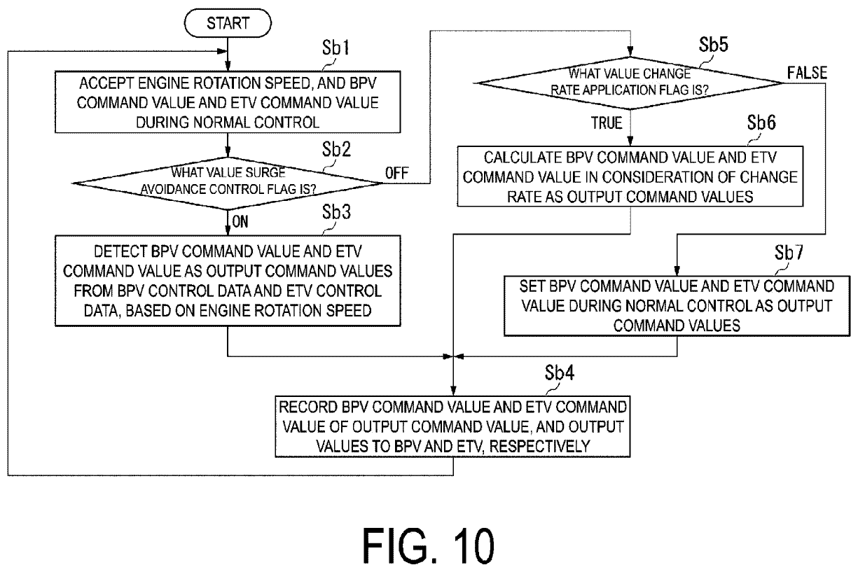

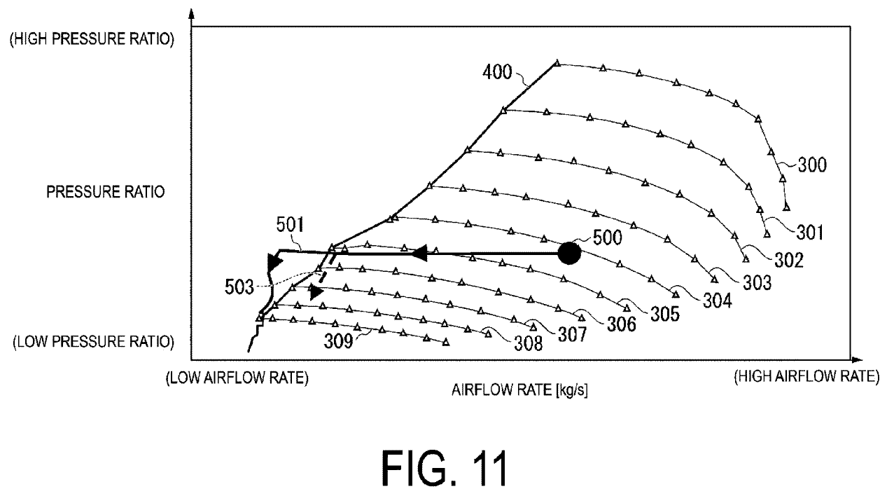

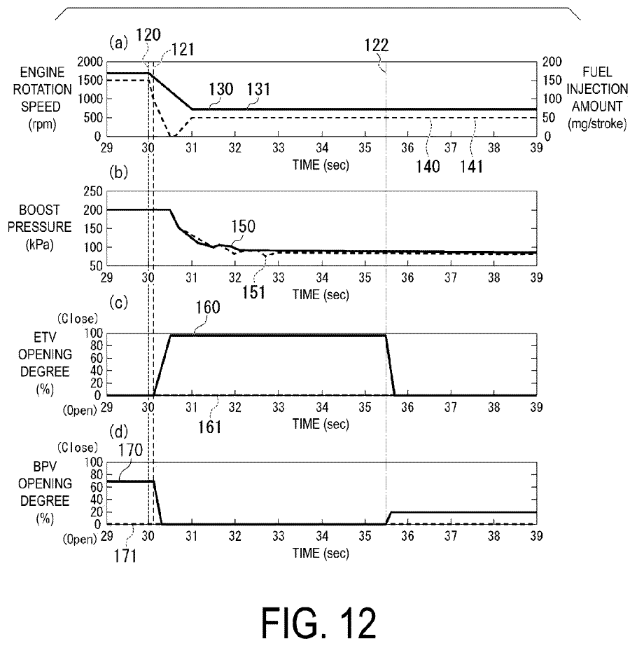

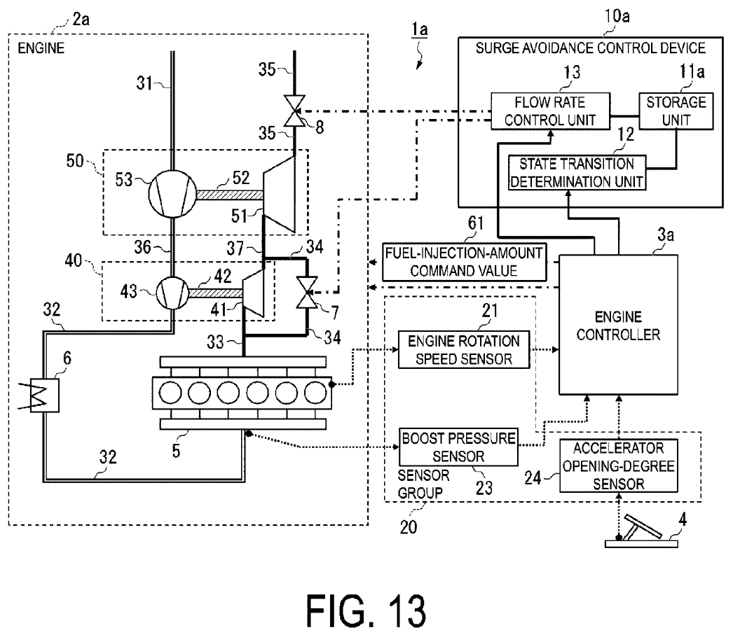

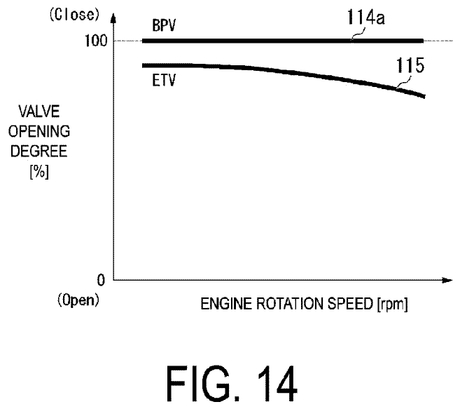

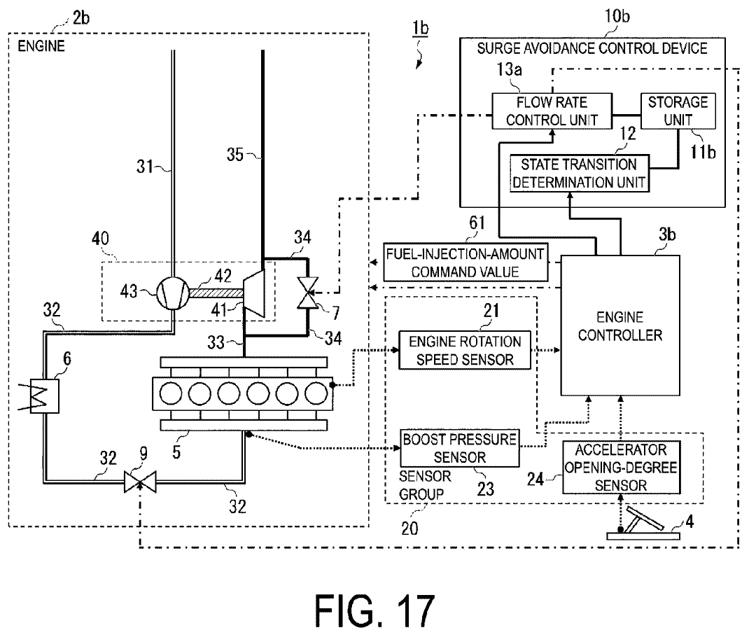

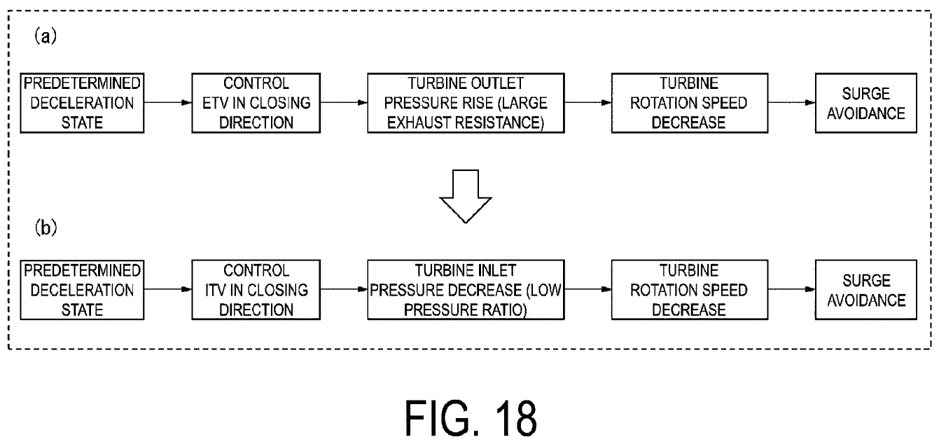

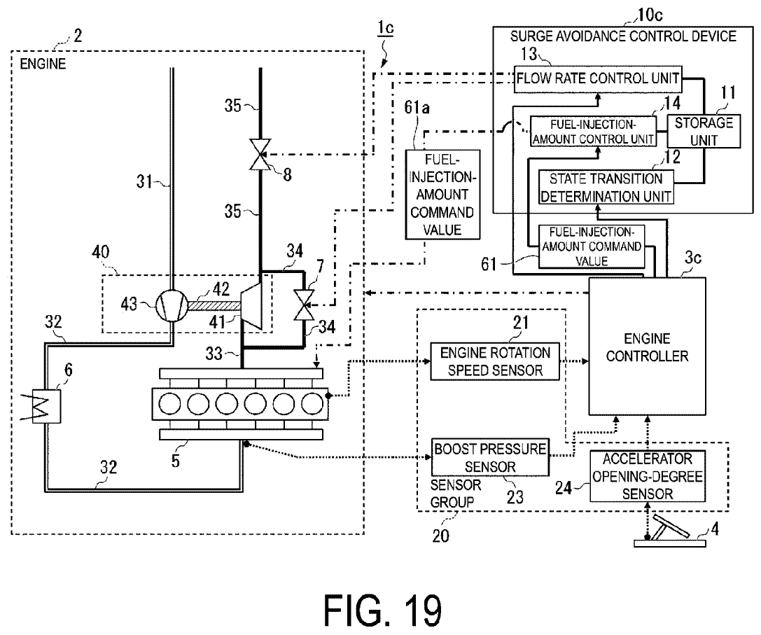

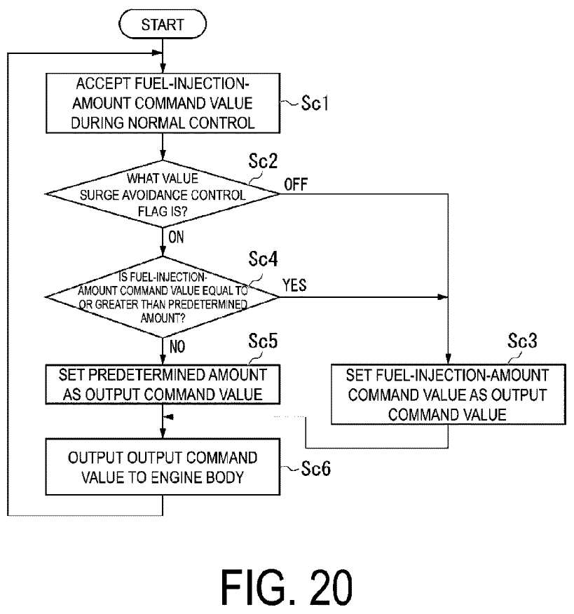

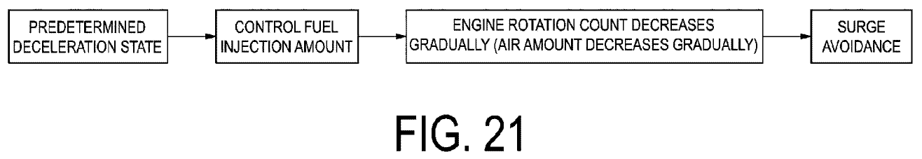

FIG. 1 is a schematic block diagram illustrating a configuration of an internal combustion engine system 1 according to a first embodiment. FIGS. 2 to 8 are diagrams illustrating examples. of formats of data stored in a storage unit 11 of a surge avoidance control device 10 according to the first embodiment: FIG. 9 is a flowchart showing the flow of processing performed by a state transition determination unit 12 according to the first embodiment. FIG. 10 is a flowchart showing the flow of processing performed by a flow rate control unit 13 according to the first embodiment. FIG. 11 is a graph showing an example of characteristics of a compressor 43 according to the first embodiment. FIG. 13 is a schematic block diagram illustrating a configuration of an internal combustion engine system la according to a second embodiment. FIG. 14 is a graph showing an example of exhaust throttle valve control data 115 and bypass valve control data 114a according to the second embodiment. FIGS. 12, 15, and 16 are diagrams showing graphs comparing examples of a change when the internal combustion engine systems 1 and la according to the first and second embodiments and another configuration example of the internal combustion engine system la according to the second embodiment are used and an example of a change when a general internal combustion engine system is used. FIG. 17 is a schematic block diagram illustrating a configuration of an internal combustion engine system 1b according to a third embodiment. FIG. 18 is a diagram illustrating a comparison of the action of the internal combustion engine system 1 according to the first embodiment and the action of the internal combustion engine system 1b according to the third embodiment. FIG. 19 is a schematic block diagram illustrating a configuration of an internal combustion engine system 1c according to a fourth embodiment. FIG. 20 is a flowchart showing the flow of processing performed by a fuel-injection-amount control unit 14 according to the fourth embodiment. FIG. 21 is a diagram illustrating the action of the internal combustion engine system 1c according to the fourth embodiment.

### First Embodiment

### Overall Configuration of First Embodiment

The internal combustion engine system 1 according to the first embodiment includes an engine 2, an engine controller 3, an accelerator pedal 4, the surge avoidance control device 10, and a sensor group 20 as illustrated in FIG. 1. The internal combustion engine system 1 is provided in a construction machine, for example, an excavator or a dump truck. The accelerator pedal 4 is installed in, for example, the driver's seat of the construction machine and is operated by a driver.

The engine 2 is a so-called internal combustion engine, for example, a diesel engine. The engine 2 includes an engine body 5, an aftercooler 6, a by passvalve (hereinafter also referred to as a ‘BPV’) 7, an exhaust throttle valve (hereinafter also referred to as an ‘ETV’) 8, an exhaust turbine supercharger 40, and passages 31 to 35.

The exhaust turbine supercharger 40 includes a turbine 41, the compressor 43, and a shaft 42 that couples the turbine 41 and the compressor 43 to transmit a driving force for rotation of the turbine 41 to the compressor 43. The turbine 41 is connected to the engine body 5 via the turbine-side exhaust passage 33, receives the exhaust gas discharged from the engine body 5 and rotates to discharge the exhaust gas to the outlet-side exhaust passage 35.

The compressor 43 is also called a blower or a compressor, rotates in conjunction with the rotation of the turbine 41, and compresses air, that is, an intake gas, flowing in from the inlet-side intake passage 31. The compressor 43 is connected to the engine body 5 via the engine-body-side intake passage 32, and discharges the compressed intake gas to the engine-body-side intake passage 32. The aftercooler 6 is inserted into the engine-body-side intake passage 32, and cools the intake gas whose temperature has been increased due to compression by the compressor 43. The engine body 5 takes in the intake gas supplied from the engine-body-side intake passage 32. The engine body 5 mixes the fuel injected according to a fuel-injection-amount command value 61 and the intake gas taken and combusts them, thereby generating a driving force for rotation. The engine body 5 discharges the exhaust gas generated from the combustion to the turbine-side exhaust passage 33.

The bypass passage 34 is a passage provided to bypass the turbine 41, and is provided such that the bypass passage branches off from the turbine-side exhaust passage 33 and joins the outlet-side exhaust passage 35. The bypass valve 7 is a flow rate regulator that regulates the flow rate of the exhaust gas passing through the bypass passage 34 and is inserted into the bypass passage 34. By regulating the opening degree of the bypass valve 7, the flow rate of the exhaust gas accepted by the turbine 41 is regulated, and thereby the supercharging pressure, that is, the boost pressure, is regulated.

The exhaust throttle valve 8 is a flow rate regulator that regulates the flow rate of the exhaust gas passing through the outlet-side exhaust passage 35 and is inserted into the outlet-side exhaust passage 35. By regulating the opening degree of the exhaust throttle valve 8, the flow rate of the exhaust gas passing through the outlet-side exhaust passage 35 is regulated, and thereby the temperature of the exhaust gas flowing into a post treatment device, which is not illustrated and connected to the end of the outlet-side exhaust passage 35 on the side opposite to the end to which the turbine 41 is connected, is regulated.

Note that, in the engine 2 illustrated in FIG. 1, the passages through which the intake gas passes, that is, the inlet-side intake passage 31 and the engine-body-side intake passage 32, are indicated by double lines, and the passages through which the exhaust gas passes, that is, the turbine-side exhaust passage 33, the bypass passage 34, and the outlet-side exhaust passage 35, are indicated by solid lines. The same applies to FIGS. 13, 17, and 19 described below.

The sensor group 20 includes a plurality of sensors that detect various states of the internal combustion engine system 1. In FIG. 1, an engine rotation speed sensor 21, a boost pressure sensor 23, and an accelerator opening-degree sensor 24 are illustrated as examples of the plurality of sensors included in the sensor group 20. Although not illustrated, the sensor group 20 includes a sensor that detects sensor data necessary for feedforward control and feedback control that the engine controller 3 performs for the engine 2, in addition to those sensors 21, 23, and 24.

The engine rotation speed sensor 21 outputs a signal corresponding to an engine rotation speed of the engine body 5, and the engine controller 3 acquires sensor data indicating the engine rotation speed detected from the signal and detection time data indicating the time at which the sensor data was detected. The boost pressure sensor 23 detects a pressure of the intake gas on the engine-body-side intake passage 32, more specifically, a boost pressure which is a pressure of the intake gas near the end of the engine-body-side intake passage 32 connected to the engine body 5, at regular intervals. The boost pressure sensor 23 outputs sensor data indicating the detected boost pressure and detection time data indicating the time at which the sensor data was detected to the engine controller 3.

The accelerator opening-degree sensor 24 outputs a signal corresponding to an accelerator opening degree, which is an opening degree of the accelerator pedal 4, and the engine controller 3 acquires sensor data indicating the accelerator opening degree detected from the signal and detection time data indicating a time at which the sensor data was detected. Here, the accelerator opening degree is expressed by, for example, a percentage, and becomes 0% in a state in which the accelerator pedal 4 is not depressed, and becomes 100% in a state in which the accelerator pedal 4 is fully depressed. Note that the engine controller 3 includes a timer means such as a clock, and acquires the time when sensor data was acquired from the timer means as detection time data.

The engine controller 3 accepts the sensor data detected by each of the plurality of sensors included in the sensor group 20 and performs various kinds of control on the engine 2 based on the accepted sensor data. The various kinds of control include processing in which the engine controller 3 calculates a fuel injection amount required to obtain the output necessary for the engine 2 and outputs the fuel injection-amount command value 61 indicating the calculated fuel injection amount to the engine 2. Upon detecting the output of the fuel-injection-amount command value 61 performed by the engine controller 3, the engine controller 3 acquires the detection time data indicating the detected time from the timer means and stores the acquired detection time data in association with the fuel injection amount indicated by the output fuel-injection-amount command value 61. However, the engine controller 3 does not directly control the bypass valve 7 and the exhaust throttle valve 8 by outputting command values for control. but outputs command values for control over the bypass valve 7 and the exhaust throttle valve 8 to a flow rate control unit 13 included in the surge avoidance control device 10.

Here, the command value that the engine controller 3 outputs to the flow rate control unit 13 with respect to the bypass valve 7 is a command value calculated in control that prevents the rotation speed of the turbine 41 from becoming excessively high. The control that prevents the rotation speed of the turbine 41 from becoming excessively high is, for example, control including feedforward control by map control based on the engine rotation speed of the engine body 5 and the fuel-injection-amount command value 61 and feedback control to set the boost pressure detected by the boost pressure sensor 23 to the boost pressure of the target value.

The command value for the exhaust throttle valve 8, which is output from the engine controller 3 to the flow rate control unit 13, is a command value calculated to bring about a state in which particulate matter (PM) and the like accumulated in the post-processing device can be combusted. The control for bringing about the state in which PM and the like accumulated in the post-treatment device can be combusted includes, for example, control including feedforward control by map control based on the engine rotation speed of the engine body 5 and the fuel-injection-amount command value 61, and feedback control for adjusting the temperature of the exhaust gas flowing into the post-processing device detected by a temperature sensor, which is not illustrated, to the temperature of the target value using additional fuel injection, which is not illustrated.

When the engine controller 3 acquires the sensor data indicating the engine rotation speed and the detection time data from the engine rotation speed sensor 21, the engine controller 3 outputs the acquired sensor data and detection time data to the flow rate control unit 13 and the state transition determination unit 12 included in the surge avoidance control device 10. The engine controller 3 outputs the fuel injection amount stored when the fuel-injection-amount command value 61 is output to the engine 2 and the detection time data to the state transition determination unit 12. When the engine controller 3 acquires the sensor data indicating the accelerator opening degree and the detection time data from the accelerator opening-degree sensor 24, the engine controller 3 outputs the acquired sensor data and the detection time data to the state transition determination unit 12. Note that, in FIG. 1, the control lines through which the data detected by each of the sensors of the sensor group 20 and the fuel-injection-amount command value 61 are transmitted are indicated by dotted-line arrows. The same applies to FIGS. 13, 17, and 19 described below.

The surge avoidance control device 10 includes the storage unit 11, the state transition determination unit 12, and the flow rate control unit 13. The storage unit 11 stores a data table 110, a surge occurrence precondition table 111, a surge avoidance control start condition table 112, a surge avoidance control termination condition table 113, bypass valve control data 114, exhaust throttle valve control data 115, a surge avoidance control flag 116, and a change rate application flag 117.

The data table 110 is a table in a data format including items such as ‘detection time’, ‘accelerator opening degree’, ‘fuel injection amount’, and ‘engine rotation speed’ as shown in FIG. 2. In the item ‘accelerator opening degree’, sensor data indicating the accelerator opening degree is written in a format expressed as a numerical value in the unit “%” In the item ‘fuel injection amount’, data indicating the fuel injection amount is written in a format expressed as a numerical value in the unit ‘mg/stroke’. In the item ‘engine rotation speed’, sensor data indicating the engine rotation speed is written in a format expressed as a numerical value in the unit ‘revolutions per minute (rpm)’, In the item ‘detection time’, detection time data corresponding to data written in any one of the items ‘accelerator opening degree’, ‘fuel injection amount’, and ‘engine rotation speed’ is written in a format expressed as a numerical value in the unit ‘hour:minute:second: 1/100 seconds’.

Note that, FIG. 2 shows an example in which values are recorded in the first and second rows and, in each record, numerical values indicating all of the detection time, the accelerator opening degree, the fuel injection amount, and the engine rotation speed are written. However, the detection times corresponding to the accelerator opening degree, the fuel injection amount, and the engine rotation speed may be the same time, but the detection times may be different times because the fuel injection amount is detected every time fuel injection is performed and the detection interval of the accelerator opening degree and the engine rotation speed may be arbitrarily determined. For this reason, some records may not include any of the accelerator opening degree, the fuel injection amount, and the engine rotation speed. In addition, in the data table 110, the records are written in chronological order in which the most recent record is the highest.

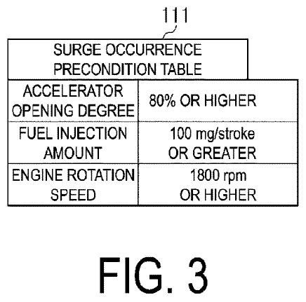

The surge occurrence precondition table 111 is a table in a data format including items ‘accelerator opening degree’, ‘fuel injection amount’, and ‘engine rotation speed’ as shown in FIG. 3. In the item ‘accelerator opening degree’, information indicating a condition of the accelerator opening degree that is a prerequisite for the occurrence of a surge is written. In the item ‘fuel injection amount’, information indicating a condition of the fuel injection amount which is a prerequisite for the occurrence of the surge is written. In the item ‘engine rotation speed’, information indicating a condition for the engine rotation speed that is a prerequisite for the occurrence of a surge is written.

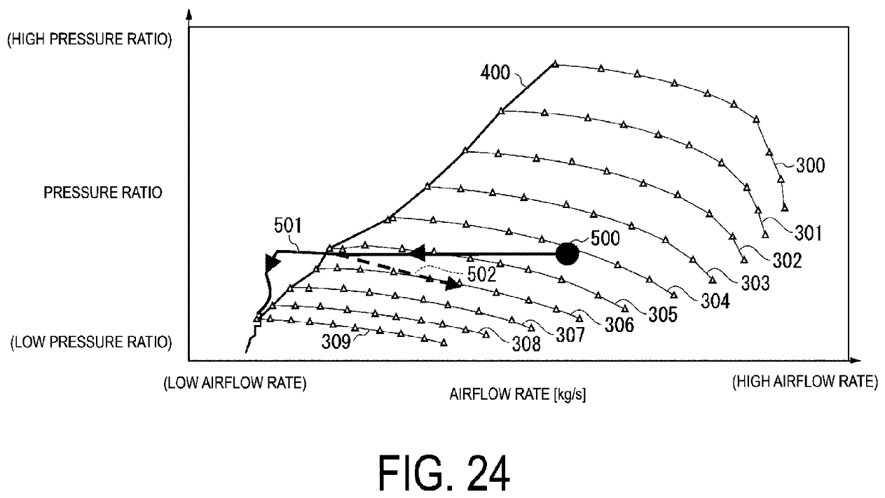

Note that the condition for the accelerator opening degree and the condition for the fuel injection amount among the preconditions for the occurrence of a surge shown in the surge occurrence precondition table 111 are conditions indicating that the operation point of the compressor 43 is estimated to be located in a region on the right side of the surge line 400 in FIG. 24 when the characteristics of the compressor 43 are, for example, the characteristics shown in the graph of FIG. 24. The condition for the engine rotation speed in the surge occurrence precondition table 111 is a condition indicating the operation point of the compressor 43 located at the position of the flow rate with respect to the ‘airflow rate’ on the horizontal axis in the graph of FIG. 24.

Generally, a surge occurs when the engine body 5 is rapidly decelerated from a state in a high-speed range or a high-load range. For this reason, the precondition for the occurrence of a surge shown in the surge occurrence precondition table 111 is determined in advance so as to be conditions under which the state of the engine body 5 is estimated to be a state in a high-speed range or a high-load range. In other words, the condition is a condition under which the operation point of the compressor 43 is estimated to be present in a region on the right side of the surge line 400 in the graph of FIG. 24 and in a region where the pressure ratio is high.

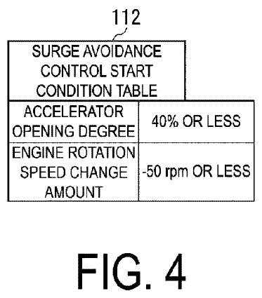

The surge avoidance control start condition table 112 is a table in a data format including items ‘accelerator opening degree’ and ‘engine rotation speed change amount’ as shown in FIG. 4. In the item ‘accelerator opening degree’, information indicating a condition of the accelerator opening degree, which is a condition for starting control to avoid a surge, is written. In the item ‘engine rotation speed change amount’, information indicating a condition of the variation of the engine rotation speed, which is a condition for starting control to avoid a surge, is written. The condition for starting control to avoid a surge shown in the surge avoidance control start condition table 112 is determined in advance so as to be a condition under which it is estimated that the state of the engine body 5 has started to transition to a state in a low-speed range or a low-load range. In other words, the condition is a condition under which it is estimated that the operation point of the compressor 43 starts to move in the direction in which the airflow rate decreases in the graph of FIG. 24.

Therefore, a state in which the condition for starting control to avoid a surge indicated in the surge avoidance control start condition table 112 is satisfied while the precondition for the occurrence of a surge indicated in the surge occurrence precondition table 111 is satisfied is a state in which it is estimated that the state of the engine body 5 has started to transition from the state in the high-speed range to the state in the low-speed range or a state in which it is estimated that the state of the engine body has started to transition from the state in the high-load range to the state in the low-load range, and this state will be referred to as a ‘predetermined deceleration state’ hereinbelow.

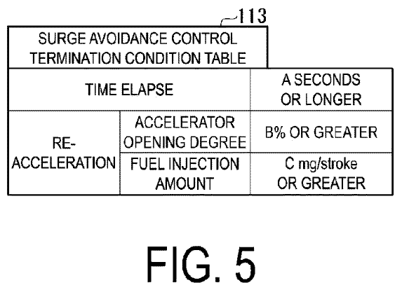

The surge avoidance control termination condition table 113 is a table in a data format including items ‘time elapse’ and ‘re-acceleration’, and further including sub-items of ‘accelerator opening degree’ and ‘fuel injection amount’ in the item ‘re-acceleration’ as shown in FIG. 5. In the item ‘time elapse’, information indicating a condition for time elapse, which is a termination condition for control to avoid a surge, is written. A surge is a phenomenon that temporarily occurs, and no surge occurs after a certain period of time elapses. For this reason, by setting the certain time as a predetermined surge avoidance control time in advance and indicating the predetermined surge avoidance control time in the condition of the time elapse indicated in the item ‘time elapse’, it is possible to determine whether the state has transitioned to the state in which no surge occurs.

In the sub-item ‘accelerator opening degree’ of ‘re-acceleration’, information indicating a condition of the accelerator opening degree, which is a termination condition for control to avoid a surge, is written. In the sub-item ‘fuel injection amount’ of ‘re-acceleration’, information indicating a condition of the fuel injection amount, which is a termination condition for control to avoid a surge is written. When re-acceleration is performed, the engine body 5 takes in an intake gas, and thus it is not the state in which a surge occurs. For this reason, by indicating the re-acceleration condition with the two items ‘accelerator opening degree’ and ‘fuel injection amount’, it is possible to determine whether the state has transitioned to the state in which no surge occurs.

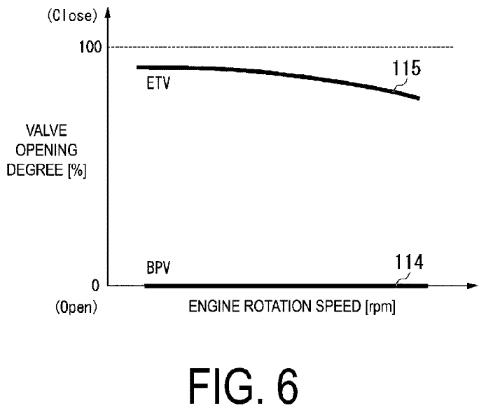

Each of the bypass valve control data 114 and the exhaust throttle valve control data 115 is, for example, data showing the characteristics of the graph shown in FIG. 6. However, FIG. 6 is a diagram showing the characteristics of the bypass valve control data 114 and the exhaust throttle valve control data 115 using a graph. In practice, the bypass valve control data 114 is data in a table format for map control including each of a plurality of different engine rotation speeds and a command value for the bypass valve 7 associated with each of the engine rotation speeds in advance. In addition, the exhaust throttle valve control data 115 is also data in a table format for map control including each of a plurality of different engine rotation speeds and a command value for the exhaust throttle valve 8 associated with each of the engine rotation speeds in advance. Note that both the opening degree of the bypass valve 7, which is a command value for the bypass valve 7, and the opening degree of the exhaust throttle valve 8, which is a command value for the exhaust throttle valve 8, indicate full opening at 0% and full closing at 100%.

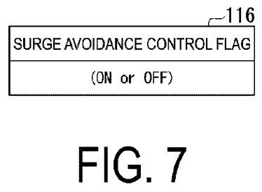

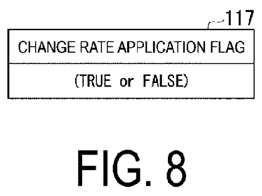

Either ‘ON’ indicating that the surge avoidance control is performed or ‘OFF’ indicating that the surge avoidance control is not performed is written as a flag value in the surge avoidance control flag 116 as shown in FIG. 7. Either ‘TRUE’ indicating that the change rate is applied or ‘FALSE’ indicating that the change rate is not applied is written as a flag value in the change rate application flag 117 as shown in FIG. 8.

The state transition determination unit 12 determines whether the state of the engine body 5 has transitioned to a predetermined deceleration state in which it is estimated that a surge could occur in the exhaust turbine supercharger 40. If the state transition determination unit 12 determines that the state has transitioned to the predetermined deceleration state, the flow rate control unit 13 outputs command values to the bypass valve 7 and the exhaust throttle valve 8 so that the flow rate of the exhaust gas to be supplied to the turbine 41 of the exhaust turbine supercharger 40 becomes a flow rate that reduces the rotation speed of the turbine 41. Note that, in FIG. 1, control lines through which data such as a command value used when the engine 2 is controlled is transmitted are indicated by dashed-line arrows. The same applies to FIGS. 13, 17, and 19 described below.

### Processing by Surge Avoidance Control Device of First Embodiment

FIG. 9 is a flowchart showing the flow of processing by the state transition determination unit 12, and FIG. 10 is a flowchart showing the flow of processing by the flow rate control unit 13. The processing operations of FIGS. 9 and 10 are performed in parallel. In parallel with the processing operations of FIGS. 9 and 10, control processing for the engine 2 including processing by sensors such as the engine rotation speed sensor 21, the boost pressure sensor 23, and the accelerator opening-degree sensor 24 and processing of calculating the fuel injection amount and outputting the fuel-injection-amount command value 61 by the engine controller 3 is also performed.

Before the processing operations of FIGS. 9 and 10 are performed, the information shown in FIGS. 3, 4, and 5 is written in advance in the surge occurrence precondition table 111, the surge avoidance control start condition table 112, and the surge avoidance control termination condition table 113 in the storage unit 11. Furthermore, the storage unit 11 stores the bypass valve control data 114 and the exhaust throttle valve control data 115 having the characteristics shown in FIG. 6 in advance.

### Processing by State Transition Determination Unit of First Embodiment

When the power of the construction machine including the internal combustion engine system 1 is turned on, for example, the state transition determination unit 12 of the surge avoidance control device 10 is activated and starts the processing of the flowchart of FIG. 9. The state transition determination unit 12 writes ‘OFF’ to the surge avoidance control flag 116 for initialization, and writes ‘FALSE’ to the change rate application flag 117 for initialization. The state transition determination unit 12 further initializes the data table 110 to a state in which no record exists (Sa1).

The state transition determination unit 12 waits until there is an output from the engine controller 3. When the engine controller 3 outputs any one of a combination of the sensor data indicating the accelerator opening degree and the detection time data corresponding to the sensor data, a combination of the data indicating the fuel injection amount and the detection time data corresponding to the data, and a combination of the sensor data indicating the engine rotation speed and the detection time data corresponding to the sensor data, the state transition determination unit 12 accepts the output data and records the data in the data table 110 (Sa2).

The state transition determination unit 12 refers to the flag value of the surge avoidance control flag 116 and determines whether the flag value is ‘ON’ or ‘OFF’ (Sa3). If the state transition determination unit 12 determines that the flag value of the surge avoidance control flag 116 is ‘ON’ (Sa3; ON), the state transition determination unit 12 then performs the processing of Sa5.

On the other hand, if the state transition determination unit 12 determines that the flag value of the surge avoidance control flag 116 is ‘OFF’ (Sa3; OFF), the state transition determination unit 12 determines whether the state has transitioned to a predetermined deceleration state. That is, the state transition determination unit 12 determines whether the precondition for the occurrence of a surge indicated in the surge occurrence precondition table 111 has been satisfied and the start condition for the control to avoid a surge indicated in the surge avoidance control start condition table 112 has been satisfied (Sa4). More specifically, the state transition determination unit 12 performs the following processing as the processing of the Sa4. However, in the following description, it is assumed that each of the records stored in the data table 110 includes all of the detection time, the accelerator opening degree, the fuel injection amount, and the engine rotation speed as shown in FIG. 2.

The state transition determination unit 12 refers to the most recent record in the data table 110, that is, the highest record in the data table 110, and detects the detection time recorded in the item “detection time” of the referred record to set the detection time as the reference time.

The state transition determination unit 12 detects a record of a predetermined time before the reference time from the data table 110, and reads the accelerator opening degree, the fuel injection amount, and the engine rotation speed recorded in the items ‘accelerator opening degree’, ‘fuel injection amount’, and ‘engine rotation speed’ of the detected record. Here, the predetermined time is, for example, 0.5 seconds.

The state transition determination unit 12 determines whether the read accelerator opening degree, fuel injection amount, and engine rotation speed have satisfied all of the preconditions for the occurrence of a surge indicated in the surge occurrence precondition table 111, that is, the three conditions of the condition that the accelerator opening degree is ‘80% or higher’, the condition that the fuel injection amount is ‘100 mg/stroke or greater’, and the condition that the engine rotation speed is ‘1800 rpm or higher’. If the state transition determination unit 12 determines that all the three conditions have been satisfied, it determines that the preconditions for the occurrence of a surge have been satisfied, and if the state transition determination unit 12 determines that all the three conditions have not been satisfied, it determines that the preconditions for the occurrence of a surge have not been satisfied.

If the state transition determination unit 12 determines that the preconditions for the occurrence of a surge have been satisfied, the state transition determination unit 12 reads the most recent records of the data table 110, that is, the accelerator opening degree and the engine rotation speed recorded in the respective items ‘accelerator opening degree’ and ‘engine rotation speed’ corresponding to the reference time. The state transition determination unit 12 calculates the engine rotation speed change amount by subtracting the engine rotation speed at a predetermined time before the reference time from the engine rotation speed corresponding to the reference time. The state transition determination unit 12 determines whether the accelerator opening degree corresponding to the reference time and the calculated engine rotation speed change amount satisfy the start conditions for control to avoid a surge indicated in the surge avoidance control start condition table 112, that is, the two conditions of the condition that the accelerator opening degree is ‘40% or less’ and the condition that the engine rotation speed change amount is ‘−50 rpm or less’. If the state transition determination unit 12 determines that both of the two conditions have been satisfied, the state transition determination unit 12 determines that the start conditions for the control to avoid a surge have been satisfied, and if the state transition determination unit 12 determines that neither of the two conditions have been satisfied, the state transition determination unit 12 determines that the start conditions for the control to avoid a surge have not been satisfied.

In the processing of Sa4, if it is determined that the preconditions for the occurrence of a surge have not been satisfied, and if it is determined that the preconditions for the occurrence of a surge have been satisfied but the start conditions for the control to avoid a surge have not been satisfied, the state transition determination unit 12 determines that the state has not transitioned to the predetermined deceleration state (Sa4; No) and performs the processing of Sa2 again. On the other hand, if it is determined in the processing of Sa4 that the preconditions for the occurrence of a surge have been satisfied and that the start conditions for the control to avoid a surge have been satisfied, the state transition determination unit 12 determines that the state has transitioned to the predetermined deceleration state (Sa4; Yes), and then performs the processing of Sa5.

The state transition determination unit 12 determines whether the termination condition for control to avoid a surge indicated in the surge avoidance control start condition table 112 has been satisfied (Sa5). Here, the processing performed thereafter will be described assuming that the state transition determination unit 12 determines that the termination condition for the control to avoid a surge has not been satisfied, that is, determines ‘No’ in the processing of the Sa5. The state transition determination unit 12 refers to the flag value of the change rate application flag 117, rewrites the flag value to ‘FALSE’ if the flag value is ‘TRUE’, and maintains the state if the flag value of the change rate application flag 117 is ‘FALSE’ (Sa6). Therefore, after the processing of Sa6, the flag value of the change rate application flag 117 becomes ‘FALSE’.

The state transition determination unit 12 refers to the flag value of the surge avoidance control flag 116, rewrites the flag value to ‘ON’ if the flag value is ‘OFF’, and maintains the state if the flag value of the surge avoidance control flag 116 is ‘ON’ (Sa7). Therefore, after the processing of Sa7, the flag value of the surge avoidance control flag 116 becomes ‘ON’. When the control time measurement timer provided inside is not activated, the state transition determination unit 12 initializes and activates the control time measurement timer. Note that when the control time measurement timer is initialized and activated, the control time measurement timer measures the time elapsed in units of, for example, 1 second with ‘0 seconds’ as a starting point. On the other hand, if the control time measurement timer has already been activated, the state transition determination unit 12 maintains the state (Sa8). The state transition determination unit 12 performs the processing of Sa2 again after the processing of Sa8 and performs the processing of Sa3 again after the processing of Sa2.

Here, the flag value of the surge avoidance control flag 116 is ‘ON’. For this reason, the state transition determination unit 12 determines ‘ON’ in the processing of Sa3 (Sa3; ON), and performs the processing of Sa5 again. The state transition determination unit 12 refers to the most recent record in the data table 110 and reads the most recent accelerator opening degree recorded in the item ‘accelerator opening degree’ and the most recent fuel injection amount recorded in the item ‘fuel injection amount’ of the corresponding record.

The state transition determination unit 12 refers to the timer value of the control time measurement timer and performs a first termination condition determination process of determining whether the number of seconds of the reference timer value satisfies the condition ‘A seconds or longer’ indicated in the item ‘time elapse’ of the surge avoidance control termination condition table 113. The state transition determination unit 12 performs a second termination condition determination process of determining whether the most recent read accelerator opening degree satisfies the condition ‘B % or greater’ indicated in the sub-item ‘accelerator opening degree’ of the item ‘re-acceleration’ in the surge avoidance control termination condition table 113. The state transition determination unit 12 performs a third termination condition determination process of determining whether the most recent read fuel injection amount satisfies the condition ‘C mg/stroke or greater’ indicated in the sub-item ‘fuel injection amount’ of the item ‘re-acceleration’ in the surge avoidance control termination condition table 113.

If the state transition determination unit 12 determines that a condition has been satisfied in any one of the first termination condition determination process, the second termination condition determination process, and the third termination condition determination process, the state transition determination unit 12 determines that the termination conditions for the control to avoid a surge have been satisfied. If the state transition determination unit 12 determines that no condition has been satisfied in all the termination condition determination processes including the first termination condition determination process, the second termination condition determination process, and the third termination condition determination process, the state transition determination unit 12 determines that the termination conditions for the control to avoid a surge have not been satisfied (Sa5). Note that, when the control time measurement timer is not activated, the state transition determination unit 12 determines that no condition has been satisfied in the first termination condition determination process.

As described above, if the state transition determination unit 12 determines that the termination condition for control to avoid a surge has not been satisfied (Sa5; No), the state transition determination unit 12 performs the processing of Sa6 next. On the other hand, if the state transition determination unit 12 determines that the termination conditions for the control to avoid a surge have been satisfied (Sa5; Yes), the state transition determination unit 12 performs the processing of Sa9.

In the processing of Sa5, the state transition determination unit 12 writes and stores the determination results of the first termination condition determination process, the second termination condition determination process, and the third termination condition determination process in an internal storage area. If the state transition determination unit 12 determines that the condition has been satisfied in the first termination condition determination process and determines that no conditions have been satisfied in the second and third termination condition determination processes, the state transition determination unit 12 determines that the termination condition ‘time elapse’ has been satisfied. Conversely, if the state transition determination unit 12 determines that the condition has not been satisfied in the first termination condition determination process and determines that the condition has been satisfied in any one of the second and third termination condition determination processes, the state transition determination unit 12 determines that the termination condition ‘re-acceleration’ has been satisfied. Note that, if the state transition determination unit 12 determines that the condition has been satisfied in the first termination condition determination process and determines that the condition has been satisfied in any one of the second and third termination condition determination processes, the state transition determination unit 12 determines that the termination condition ‘re-acceleration’ has been satisfied by putting priority to ‘re-acceleration’ over ‘time elapse’ (Sa9).

The state transition determination unit 12 refers to the flag value of the change rate application flag 117 upon the determination that the termination condition ‘re-acceleration’ has been satisfied (Sa9; re-acceleration), rewrites the flag value to ‘FALSE’ if the flag value is ‘TRUE’, and maintains the state if the flag value of the change rate application flag 117 is ‘FALSE’ (Sa10). Therefore, after the processing of Sa10, the flag value of the change rate application flag 117 becomes ‘FALSE’. After the processing of Sa10, the state transition determination unit 12 performs the processing of Sa12.

On the other hand, the state transition determination unit 12 refers to the flag value of the change rate application flag 117 upon the determination that the termination condition ‘time elapse’ has been satisfied (Sa9; time elapse), rewrites the flag value to“TRUE” if the flag value is ‘FALSE’, and maintains the state if the flag value of the change rate application flag 117 is ‘TRUE’ (Sa11). Therefore, after the processing of Sa11, the flag value of the change rate application flag 117 becomes ‘TRUE’.

After the processing of Sa10 and Sa11, the state transition determination unit 12 refers to the flag value of the surge avoidance control flag 116, rewrites the flag value to ‘OFF’ if the flag value is ‘ON’, and maintains the state if the flag value of the surge avoidance control flag 116 is ‘OFF’ (Sa12). Therefore, after the processing of Sa12, the flag value of the surge avoidance control flag 116 becomes ‘OFF’. The state transition determination unit 12 stops the control time measuring timer (Sa13) and performs the processing of Sa2 again.

The processing shown in FIG. 9 is repeatedly performed while the power of the construction machine is on and ends if the power of the construction machine is turned off. In the processing of Sa4 and Sa5 in the processing in FIG. 9, the state transition determination unit 12 refers to the highest record when referring to the most recent record in the data table 110. In contrast, the state transition determination unit 12 may refer to the most recent sensor data of each of the items ‘accelerator opening degree’, ‘fuel injection amount’, and ‘engine rotation speed’ in the data table 110, instead of referring to the most recent records of the data table 110.

For example, it is assumed that the accelerator opening degree and the engine rotation speed are included in the highest records of the data table 110, but the fuel injection amount is not included. In this case, the state transition determination unit 12 may detect the most recent record including the fuel injection amount in the data table 110, set the fuel injection amount included in the detected record as the most recent fuel injection amount, and set the accelerator opening degree and the engine rotation speed included in the highest record as the most recent accelerator opening degree and the most recent engine rotation speed. However, in this case, the state transition determination unit 12 has two detection times as the reference time. For this reason, the state transition determination unit 12 may set either one of the detection times as the reference time, or may set the average value of the two detection times as the reference time. Furthermore, of the two detection times, the detection time corresponding to the accelerator opening degree and the engine rotation speed may be set as the reference time corresponding to the accelerator opening degree and the engine rotation speed, and the detection time corresponding to the fuel injection amount may be set as the reference time corresponding to the fuel injection amount. In this case, the records from a predetermined time before the reference time required in the processing of Sa4 are different with respect to the combination of the accelerator opening degree and the engine rotation speed and the fuel injection amount.

In the processing of FIG. 9, the predetermined time is, for example, 0.5 seconds, but is not limited to 0.5 seconds, and may be set to any other time. In addition, if there is no record from the predetermined time before the reference time in the data table 110, the state transition determination unit 12 may refer to the highest record among the records from the predetermined time before the reference time. Furthermore, when any one of the accelerator opening degree, the fuel injection amount, and the engine rotation speed to be read is not included in the record, the state transition determination unit 12 may read the sensor data of the reading target from the highest record among the records from the predetermined time before the reference time including the reading target, for reading targets that are not included.

In the processing of FIG. 9 described above, the processing of Sa6, Sa7, and Sa8 may be performed in the described order, may be performed in an order in which the order is arbitrarily changed, or may be performed in parallel. In the processing of FIG. 9, the processing of Sa12 and Sa13 may be performed in the described order, may be performed in the reverse order, or may be performed in parallel. If the state transition determination unit 12 determines ‘Yes’ in the processing of Sa5 in FIG. 9, the processing operations of Sa12 and Sa13 may be performed in any order or in parallel before the processing of Sa9 is performed. If the state transition determination unit 12 determines ‘Yes’ in the processing of Sa5 in FIG. 9, one of the processing operations of Sa12 and Sa13 may be performed before the processing of Sa9 is performed, and the other may be performed after the processing operations of Sa10 or Sa11.

### Processing by Flow Rate Control Unit of First Embodiment

For example, if the power of the construction machine including the internal combustion engine system 1 is turned on, the flow rate control unit 13 of the surge avoidance control device 10 is activated and starts the processing of the flowchart of FIG. 10. The flow rate control unit 13 waits until there is an output from the engine controller 3. When the engine controller 3 outputs the sensor data indicating the engine rotation speed and the data of the command value during normal control to each of the bypass valve 7 and the exhaust throttle valve 8, the flow rate control unit 13 accepts the output data and writes and stores the accepted data in the internal storage area as the most recent data (Sb1).

Here, the command values for the bypass valve 7 and the exhaust throttle valve 8 during normal control are command values calculated by the engine controller 3 using sensor data acquired from the sensors included in the sensor group 20 to perform the above-described control for preventing the rotation speed of the turbine 41 from becoming excessively high and to set a state in which particulate matter (PM) and the like accumulated in the post-processing device can be combusted. Hereinafter, the command value for the bypass valve 7 is also referred to as a BVP command value, and the command value for the exhaust throttle valve 8 is also referred to as an ETV command value.

The flow rate control unit 13 refers to the flag value of the surge avoidance control flag 116 and determines whether the flag value is ‘ON’ or ‘OFF’ (Sb2). It is assumed that the flow rate control unit 13 determines that the flag value of the surge avoidance control flag 116 is ‘ON’ (Sb2; ON). In this case, the flow rate control unit 13 detects the BPV command value and the ETV command value corresponding to the most recent engine rotation speed stored in the internal storage area from the bypass valve control data 114 and the exhaust throttle valve control data 115, respectively. The flow rate control unit 13 sets the detected BPV command value and ETV command value as the respective output command values (Sb3). After the processing of Sb3, the flow rate control unit 13 performs the processing of Sb4.

On the other hand, if the flow rate control unit 13 determines that the flag value of the surge avoidance control flag 116 is ‘OFF’ (Sb2; OFF), the flow rate control unit 13 refers to the flag value of the change rate application flag 117 and determines whether the flag value is ‘TRUE’ or ‘FALSE’ (Sb5). It is assumed that the flow rate control unit 13 determines that the flag value of the change rate application flag 117 is ‘TRUE’ (Sb5; TRUE). In this case, the flow rate control unit 13 reads the BPV command value and the ETV command value of the previous output command value stored in the internal storage area.

The flow rate control unit 13 calculates the BPV command value to be set to an output command value based on the read previous BPV command value, the BPV command value during the most recent normal control stored in the internal storage area, and a predetermined change rate. For example, it is assumed that the predetermined change rate is ‘½’ in the flow rate control unit 13. In this case, the flow rate control unit 13 calculates a new BPV command value by adding a multiplication value obtained by multiplying a subtraction value, which is obtained by subtracting the previous BPV command value from the BPV command value during the most recent normal control, by ‘½’, which is the change rate, to the previous BPV command value. The flow rate control unit 13 sets the calculated new BPV command value as the output command value.

Likewise, the flow rate control unit 13 calculates a new ETV command value by adding a multiplication value obtained by multiplying a subtraction value, which is obtained by subtracting the previous ETV command value from the ETV command value during the most recent normal control, by ‘½’, which is the change rate, to the previous ETV command value. The flow rate control unit 13 sets the calculated new ETV command value as the output command value. Note that, when the previous BPV command value and the previous ETV command value are not stored in the internal storage area, the flow rate control unit 13 sets the BPV command value during the most recent normal control and the ETV command value during the most recent normal control stored in the internal storage area as output command values, respectively (Sb6). After the processing of Sb6, the flow rate control unit 13 performs the processing of Sb4.

On the other hand, if the flow rate control unit 13 determines that the flag value of the change rate application flag 117 is ‘FALSE’ in the processing of Sb5 (Sb5; FALSE), the flow rate control unit 13 sets the BPV command value during the most recent normal control and the ETV command value during the most recent normal control stored in the internal storage area as respective output command values, respectively (Sb7). After the processing of Sb7, the flow rate control unit 13 performs the processing of Sb4.

After the processing of Sb3, Sb6, and Sb7, the flow rate control unit 13 rewrites the previous BPV command value stored in the internal storage area to the BPV command value set as the output command value, and rewrites the previous ETV command value to the ETV command value set as the output command value. Note that when the previous BPV command value and the previous ETV command value are not stored in the internal storage area, the BPV command value and the ETV command value, which are the output command values, are written in the internal storage area as the previous BPV command value and the previous ETV command value, respectively. The flow rate control unit 13 outputs the BPV command value set as the output command value to the bypass valve 7, and outputs the ETV command value set as the output command value to the exhaust throttle valve 8. After outputting the BPV command value and the ETV command value, the flow rate control unit 13 deletes the most recent data stored in the internal storage area, that is, the sensor data indicating the engine rotation speed accepted in the processing of Sb1 and the data of the command values for the bypass valve 7 and the exhaust throttle valve 8 during normal control (Sb4). After the processing of Sb4, the flow rate control unit 13 performs the processing of Sb1 again.

The processing shown in FIG. 10 is repeatedly performed while the power of the construction machine is on and ends if the power of the construction machine is turned off. It has been described that, in the processing of Sb1 described above, the engine controller 3 outputs the sensor data indicating the engine rotation speed and data of the command values for each of the bypass valve 7 and the exhaust throttle valve 8 during the normal control. In contrast, it is assumed that the engine controller 3 does not output the sensor data indicating the engine rotation speed, the data of the BPV command value during the normal control, and the data of the ETV command value during the normal control to the flow rate control unit 13 at the same timing, but outputs the data to the flow rate control unit 13 at different timings. In this case, in the processing of Sb1, the flow rate control unit 13 accepts only the sensor data indicating the engine rotation speed output by the engine controller 3, and writes and stores the accepted sensor data as the most recent data in the internal storage area, and then performs the processing of Sb2.

For each of the BPV command value during the normal control and the ETV command value during the normal control, the flow rate control unit 13 performs processing different from the processing of the flowchart shown in FIG. 10 in parallel. That is, the flow rate control unit 13 waits until the engine controller 3 outputs either the data of the BPV command value during the normal control or the data of the ETV command value during the normal control. When the engine controller 3 outputs either data, the flow rate control unit 13 repeatedly performs the processing of accepting the output data, writing and storing the data in the internal storage area as the most recent data, and then waiting until the engine controller 3 outputs either the data of the BPV command value during the normal control or the data of the ETV command value during the normal control again.

### Operation and Effect of First Embodiment

FIG. 11 is a diagram showing a part of the diagram shown in FIG. 24 again, and here, FIG. 11 is a diagram showing the characteristics of the compressor 43 in the first embodiment. The state in which it is determined in the processing of Sa4 shown in FIG. 9 that the preconditions for the occurrence of a surge shown in the surge occurrence precondition table 111 have been satisfied is a state in which it is estimated that the operation point of the compressors 43 is at a position included in a region on the right side of the surge line 400 and at which the engine rotation speed is ‘1800 rpm or higher’ in FIG. 11. This position is, for example, the position indicated by reference numeral 500. The state in which it is determined in the processing of Sa4 that the start conditions for the control to avoid a surge shown in the surge avoidance control start condition table 112 have been satisfied indicates a state in which it is estimated that the operation point of the compressors 43 starts to move from the position indicated by reference numeral 500 on the line indicated by reference numeral 501 in the direction of the arrow. Therefore, if the state transition determination unit 12 determines that the state has transitioned to the predetermined deceleration state in the processing of Sa4, it is estimated that the operation point of the compressors 43 is at the position on the line indicated by reference numeral 501 and on the right side of the surge line 400.

In this state, if the state transition determination unit 12 determines that the termination conditions for the control to avoid a surge shown in the surge avoidance control termination condition table 113 have not been satisfied in the processing of the Sa5, the state transition determination unit 12 rewrites the flag value of the surge avoidance control flag 116 to ‘ON’ in the processing of the Sa7. When this rewriting is performed, the flow rate control unit 13 detects, in the processing of the Sb3 in FIG. 10, the BPV command value and the ETV command value corresponding to the engine rotation speed acquired in the processing of Sb1 immediately before the aforementioned processing from the bypass valve control data 114 and the exhaust throttle valve control data 115, respectively. In the processing of Sb4, the flow rate control unit 13 outputs the detected BPV command value and ETV command value to the bypass valve 7 and the exhaust throttle valve 8, respectively.

Since the BPV command value is 0% at any engine rotation speed in the bypass valve control data 114 as shown in FIG. 6, when the processing of Sb4 is performed after the processing of Sb3, the bypass valve 7 is fully open. In contrast, the exhaust throttle valve control data 115 shows a tendency that the ETV command value slightly decreases as the engine rotation speed increases, but the ETV command value is about 80% to 95% at any engine rotation speed. Thus, when the processing of Sb4 is performed after the processing of Sb3, the exhaust throttle valve 8 is almost closed. Note that when the exhaust throttle valve 8 is fully closed, excessive pressure is applied to the turbine 41, and thus, in the exhaust throttle valve control data 115, the exhaust throttle valve 8 is prevented from being fully closed at all engine rotation speeds.

When the bypass valve 7 is fully open, most of the exhaust gas discharged from the engine body 5 passes through the bypass valve 7, and thus the flow rate of the exhaust gas to be supplied to the turbine 41 decreases. In other words, the amount of exhaust gas that the turbine 41 receives decreases, and thus the rotation speed of the turbine 41 decreases. In addition, when the exhaust throttle valve 8 is almost closed, the pressure in the outlet-side exhaust passage 35 between the exhaust throttle valve 8 and the turbine 41, in other words, the outlet pressure of the turbine 41, increases. Thus, the resistance to the exhaust gas discharged from the turbine 41 increases, the flow rate and flow velocity of the exhaust gas passing through the turbine 41 decrease, and the rotation speed of the turbine 41 decreases. The decrease in the rotation speed of the turbine 41 causes the rotation speed of the compressor 43 to decrease as well, and thus, the direction in which the operation point of the compressor 43 moves changes to the direction of the arrow indicated by reference numeral 503 in FIG. 11, leading to avoidance of a surge.

FIG. 12 shows graphs comparing an example of a change when the internal combustion engine system 1 according to the first embodiment is used with an example of a change when a general internal combustion engine system is used. Here, the general internal combustion engine system is a system in which the surge avoidance control device 10 is removed from the internal combustion engine system 1, and the engine controller 3 outputs command values during the normal control directly to the bypass valve 7 and the exhaust throttle valve 8.
(a) of FIG. 12 is a graph showing a change in the engine rotation speed detected by the engine rotation speed sensor 21 and a graph showing a change in the fuel injection amount indicated by the fuel-injection-amount command value 61. In (a) of FIG. 12, the left vertical axis represents the magnitude of the engine rotation speed expressed in the unit ‘rpm’, and the right vertical axis represents the magnitude of the fuel injection amount expressed in the unit ‘mg/stroke’.
(b) of FIG. 12 is a graph showing a change in the boost pressure detected by the boost pressure sensor 23, and the vertical axis represents the magnitude of the boost pressure expressed in the unit ‘kPa’, (c) of FIG. 12 is a graph showing a change in the opening degree of the exhaust throttle valve 8, and the vertical axis represents the opening degree of the exhaust throttle valve 8 expressed in the unit ‘%’. (d) of FIG. 12 is a graph showing a change in the opening degree of the bypass valve 7, and the vertical axis represents the opening degree of the bypass valve 7 expressed in the unit ‘%’. In (a) of FIG. 12 to (d) of FIG. 12, the horizontal axis indicates the magnitude of time expressed in the unit ‘second’.

In FIG. 12, the vertical line indicated by reference numeral 120 represents the timing at which deceleration is started. The vertical line indicated by reference numeral 121 represents the timing at which control to avoid a surge is started in the internal combustion engine system 1 of the first embodiment, that is, the timing at which the flag value of the surge avoidance control flag 116 is rewritten from ‘OFF’ to ‘ON’. The vertical line indicated by reference numeral 122 represents the timing at which control to avoid a surge is terminated in the internal combustion engine system 1 of the first embodiment, that is, the timing at which the flag value of the surge avoidance control flag 116 is rewritten from ‘ON’ to ‘OFF’.

In (a) of FIG. 12, reference numeral 130 denotes a graph showing a change in the engine rotation speed when the internal combustion engine system 1 of the first embodiment is applied. and reference numeral 131 denotes a graph showing a change in the engine rotation speed when the general internal combustion engine system is applied. As shown in (a) of FIG. 12, there is no difference between the two graphs. At the timing when deceleration is started as indicated by reference numeral 120, the engine rotation speed starts to decrease, and after 31 seconds, the engine rotation speed is maintained at a speed of about ‘700 rpm’, which is the engine rotation speed in a low idle state. Here, the low idle state refers to a state in which the engine body 5 is kept running so as not to stop the engine body 5 in a no-load state.

In (a) of FIG. 12, reference numeral 140 denotes a graph showing a change in the fuel injection amount when the internal combustion engine system I of the first embodiment is applied, and reference numeral 141 denotes a graph showing a change in the fuel injection amount when the general internal combustion engine system is applied. As shown in (a) of FIG. 12, there is no difference between the two graphs. At the timing when deceleration is started as indicated by reference numeral 120, the fuel injection amount starts to decrease and becomes ‘0 mg/stroke’ once, but then increases and maintains ‘50 mg/stroke’ which is the fuel injection amount in the low idle state.

In (c) of FIG. 12, reference numeral 160 denotes a graph showing a change in the opening degree of the exhaust throttle valve 8 when the internal combustion engine system 1 of the first embodiment is applied, and reference numeral 161 denotes a graph showing a change in the opening degree of the exhaust throttle valve 8 when the general internal combustion engine system is applied. As shown by the graph of reference numeral 160, when the internal combustion engine system 1 of the first embodiment is applied, the exhaust throttle valve 8 is closed at the timing when control to avoid a surge indicated by reference numeral 121 starts, and when the exhaust throttle valve 8 reaches a value of about 95%, this state is maintained until the timing when the control to avoid a surge indicated by reference numeral 122 is terminated. In contrast, when the general internal combustion engine system is applied as shown by the graph of reference numeral 161, the exhaust throttle valve 8 maintains the fully open state.

In (d) of FIG. 12, reference numeral 170 denotes a graph showing a change in the opening degree of the bypass valve 7 when the internal combustion engine system I of the first embodiment is applied, and reference numeral 171 denotes a graph showing a change in the opening degree of the bypass valve 7 when the general internal combustion engine system is applied. As represented by the graph of reference numeral 170, the bypass valve 7 is open at the timing when control to avoid a surge indicated by reference numeral 121 starts, and when the bypass valve 7 is in a fully open state, this state is maintained until the timing when the control to avoid a surge indicated by reference numeral 122 is terminated. In contrast, when the general internal combustion engine system is applied as shown by the graph of reference numeral 171, the bypass valve 7 maintains the fully open state.

In (b) of FIG. 12, reference numeral 150 denotes a graph showing a change in the boost pressure when the internal combustion engine system 1 of the first embodiment is applied, and reference numeral 151 denotes a graph showing a change in the boost pressure when the general internal combustion engine system is applied. In the case of the general internal combustion engine system, a pulsating change in the boost pressure appears around 31.5 seconds to 33 seconds as shown in the graph of reference numeral 151, indicating that a surge is occurring. In contrast, in the case of the internal combustion engine system 1 of the first embodiment, the boost pressure shows a change of gradual decrease as the control shown in (c) of FIG. 12 and (d) of FIG. 12 was performed in the bypass valve 7 and the exhaust throttle valve 8 as shown by the graph of reference numeral 150, indicating that no surge is occurring. Therefore, when the internal combustion engine system 1 of the first embodiment is used, even the internal combustion engine that does not employ the EGR method can avoid surges.

Here, it is assumed that the state transition determination unit 12 of the first embodiment adopts a process of determining whether the fuel injection amount is ‘0 mg/stroke’ disclosed in Patent Literature 1, instead of the process of determining whether the state has transitioned to a predetermined deceleration state of Sa4 in FIG. 9. In this case, the position of the vertical line of reference numeral 121 indicating the timing at which the control to avoid surge starts is shifted to a position near 30.5 seconds at which the fuel injection amount is “0 mg/stroke” in (a) of FIG. 12. As shown in (c) of FIG. 12 and (d) of FIG. 12, neither the ETV opening degree immediately reaches about 95%, nor the BPV opening degree immediately reaches 0%, and there is a time lag until the effect of the control to avoid a surge becomes apparent. For this reason, if the timing at which the fuel injection amount is ‘0 mg/stroke’ is set as the timing at which the control to avoid a surge starts, there is a possibility of a surge occurring before the effect of the control to avoid a surge becomes apparent. In contrast, as described above, when the state transition determination unit 12 of the first embodiment determines that the precondition for the occurrence of a surge indicated in the surge occurrence precondition table 111 is satisfied and the start condition for the control to avoid a surge indicated in the surge avoidance control start condition table 112 is satisfied, the control to avoid a surge starts on the assumption that the state has transitioned to the predetermined deceleration state in which it is estimated that a surge could occur. This makes it possible to start the control to avoid a surge at an earlier timing with a margin than the technique disclosed in Patent Literature 1, and thus it is possible to more reliably avoid a surge.

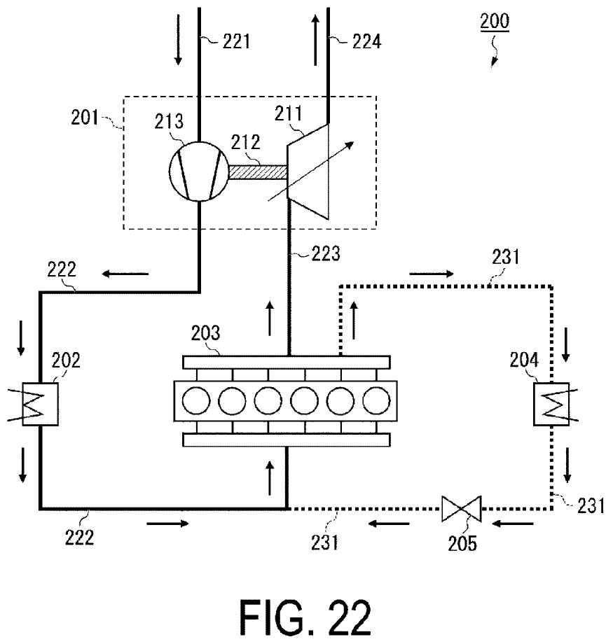

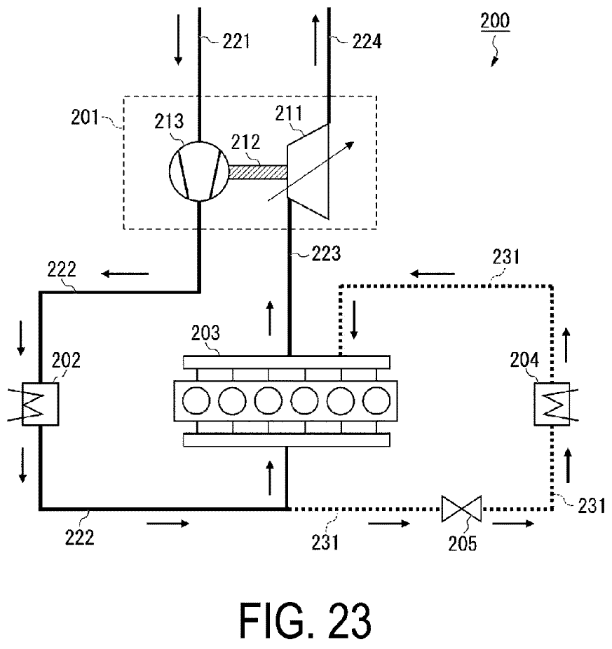

The control to avoid a surge performed by the internal combustion engine system 1 of the first embodiment is control implemented by using the bypass valve 7 and the exhaust throttle valve 8 that are provided in a general internal combustion engine, and is control that can be implemented without using an additional device such as a blow-off valve. Therefore, the control to avoid a surge implemented by the internal combustion engine system 1 of the first embodiment brings a cost advantage compared to control using an additional device to avoid a surge, and can also be applied to the internal combustion engine that adopts the EGR method illustrated in FIGS. 22 and 23.

In the internal combustion engine system 1 of the first embodiment, the state transition determination unit 12 performs the control to avoid a surge over the bypass valve 7 and the exhaust throttle valve 8 only when the state has transitioned to the predetermined deceleration state. That is, this is a configuration made in consideration of securing the robustness of the bypass valve 7 and the exhaust throttle valve 8.

In the internal combustion engine system 1 of the first embodiment, when the control to avoid a surge starts, that is, when the flag value of the surge avoidance control flag 116 is rewritten from ‘OFF’ to ‘ON’, it is necessary to immediately start the control to avoid a surge in order to avoid an abnormal state of the surge. On the other hand, when the control to avoid a surge is terminated, that is, when the surge avoidance control flag is rewritten from ‘ON’ to ‘OFF’, the following points need to be taken into consideration depending on the difference between when the control is terminated due to re-acceleration and when the control is terminated due to the elapse of time. That is, when the surge avoidance control is terminated due to re-acceleration, the surge avoidance control needs to be terminated immediately and switched to normal control because acceleration is required. In contrast. when the control to avoid the surge is terminated due to the elapse of time, the necessity for immediately switching to the normal control is low, and there is an advantage that gradual switching to the normal control imposes less load on the engine 2 than immediate switching to the normal control. In order to realize this configuration, the surge avoidance control device 10 of the first embodiment performs a process using the above-described change rate application flag 117.

To be more specific, if the state transition determination unit 12 determines that the termination condition for the control to avoid a surge indicated in the surge avoidance control termination condition table 113 has been satisfied in the processing of Sa5 in FIG. 9, the state transition determination unit 12 further determines whether the satisfied termination condition is re-acceleration or the elapse of time in the processing of Sa9. Then, the state transition determination unit 12 sets the flag value of the change rate application flag 117 to ‘FALSE’ if it is determined that the satisfied termination condition is re-acceleration, and sets the flag value of the change rate application flag 117 to ‘TRUE’ if it is determined that the satisfied termination condition is the elapse of time. If the flag value of the change rate application flag 117 is “TRUE” in the processing of Sb5 in FIG. 10, the flow rate control unit 13 performs the processing of Sb6 without immediately switching to the BPV command value and the ETV command value during normal control. In the processing of Sb6, the flow rate control unit 13 applies the change rate so that the BPV command value that was applied to the bypass valve 7 immediately before, that is, the previous BPV command value, is gradually changed to the BPV command value during the normal control. Similarly, the flow rate control unit 13 applies the change rate so that the ETV command value applied to the exhaust throttle valve 8 immediately before, that is, the previous ETV command value, is gradually changed to the ETV command value during the normal control.

### Second Embodiment

### Overall Configuration of Second Embodiment

An internal combustion engine system la according to a second embodiment includes an engine 2a, an engine controller 3a, an accelerator pedal 4, a surge avoidance control device 10a, and a sensor group 20 as illustrated in FIG. 13. Note that, the same components in the second embodiment as those in the first embodiment are denoted by the same reference numerals.

The engine 2a includes an engine body 5, an aftercooler 6, a bypass valve 7, an exhaust throttle valve 8, an exhaust turbine supercharger 40, an exhaust turbine supercharger 50, and passages 31 to 37, When the two exhaust turbine superchargers 40 and 50 are connected in series as illustrated in FIG. 13, the exhaust turbine supercharger 50 at the low-pressure stage is generally larger in size than the exhaust turbine supercharger 40 at the high-pressure stage. For this reason, in the second embodiment, the size of the exhaust turbine superchargers 40 and 50 are also set such that the size at the low-pressure stage is larger than the size at the high-pressure stage. Hereinafter, the exhaust turbine supercharger 40 will be referred to as a ‘high-pressure-stage exhaust turbine supercharger 40’, and the exhaust turbine supercharger 50 will be referred to as a ‘low-pressure-stage exhaust turbine supercharger 50’. In the second embodiment, the turbine 41 and the compressor 43 will be referred to as a high-pressure-stage turbine 41 and a high-pressure-stage compressor 43, respectively, in accordance with the change of the name of the high-pressure-stage exhaust turbine supercharger 40.

Unlike in the first embodiment, the high-pressure-stage turbine 41 is connected to the connecting exhaust passage 37 instead of the outlet-side exhaust passage 35 on the side where the exhaust gas is discharged, and discharges the exhaust gas to the connecting exhaust passage 37. Unlike the first embodiment, the high-pressure-stage compressor 43 is connected to a connecting intake passage 36 instead of the inlet-side intake passage 31 on the side where intake gas is accepted.

The low-pressure-stage exhaust turbine supercharger 50 includes a low-pressure-stage turbine 51, a low-pressure-stage compressor 53, and a shaft 52 that couples the low-pressure-stage turbine 51 and the low-pressure-stage compressor 53 and transmits a driving force of rotation of the low-pressure-stage turbine 51 to the low-pressure-stage compressor 53. The low-pressure-stage turbine 51 is connected to the high-pressure-stage turbine 41 via the connecting exhaust passage 37, and rotates by receiving exhaust gas discharged from the high-pressure-stage turbine 41 to discharge the exhaust gas to an outlet-side exhaust passage 35.

The low-pressure-stage compressor 53 is also called a blower or a compressor, similarly to the high-pressure-stage compressor 43, rotates in conjunction with the rotation of the low-pressure-stage turbine 51, and compresses air flowing in from the inlet-side intake passage 31, that is, an intake gas. The low-pressure-stage compressor 53 is connected to the high-pressure-stage compressor 43 via the connecting intake passage 36, and discharges the compressed intake gas to the connecting intake passage 36. The high-pressure-stage compressor 43 compresses the intake gas flowing in from the connecting intake passage 36 and discharges the compressed intake gas to an engine-body-side intake passage 32, and thus, the intake gas flowing in from the inlet-side intake passage 31 is compressed in two stages by the low-pressure-stage compressor 53 and the high-pressure-stage compressor 43, As a result, the engine body 5 takes in intake gas at a higher pressure than in the first embodiment.

The engine controller 3a performs feed-forward control and feedback control that are added as the control target is changed from the engine 2 to the engine 2a, in addition to the configuration of the engine controller 3 of the first embodiment.

The surge avoidance control device 10a includes a storage unit 11a, a state transition determination unit 12, and a flow rate control unit 13. The storage unit 11a stores a data table 110, a surge occurrence precondition table 111, a surge avoidance control start condition table 112, a surge avoidance control termination condition table 113, exhaust throttle valve control data 115, a surge avoidance control flag 116, and a change rate application flag 117, similarly to the storage unit 11 of the first embodiment. The storage unit 11a further stores bypass valve control data 114a having the characteristics shown in FIG. 14, instead of the bypass valve control data 114 having the characteristics shown in FIG. 6.

When the size of the low-pressure-stage exhaust turbine supercharger 50 is larger than the size of the high-pressure-stage exhaust turbine supercharger 40, the low-pressure-stage exhaust turbine supercharger 50 has greater inertia than the high-pressure-stage exhaust turbine supercharger 40. For this reason, a surge is more likely to occur in the low-pressure-stage exhaust turbine supercharger 50 than in the high-pressure-stage exhaust turbine supercharger 40. Therefore, this embodiment is on the premise that a surge is less likely to occur in the high-pressure-stage exhaust turbine supercharger 40 and a surge is more likely to occur in the low-pressure-stage exhaust turbine supercharger 50 in the engine 2a.

Based on the premise, in the second embodiment, the bypass valve control data 114a is used instead of the bypass valve control data 114. The bypass valve control data 114a is data showing the characteristic that the BPV command value is 100% at any engine rotation speed as shown in FIG. 14. Note that, as in the bypass valve control data 114 of the first embodiment, the bypass valve control data 114a is data in a map control table format in which each of a plurality of different engine rotation speeds is associated with a command value for the bypass valve 7 corresponding to the engine rotation speed.

### Processing by Surge Avoidance Control Device of Second Embodiment

In the second embodiment, the state transition determination unit 12 performs the processing shown in FIG. 9 of the first embodiment, in which the engine controller 3 is replaced with the engine controller 3a. The flow rate control unit 13 performs the processing shown in FIG. 10 of the first embodiment, in which the bypass valve control data 114 is replaced with the bypass valve control data 114a.

### Operation and Effect of Second Embodiment

Since the BPV command value is 100% at any engine rotation speed in the bypass valve control data 114a, when the processing of Sb4 is performed after the processing of Sb3 in FIG. 10, the bypass valve 7 is fully closed and the exhaust throttle valve 8 is substantially closed as in the first embodiment. When the bypass valve 7 is fully closed, the entire exhaust gas discharged from the engine body 5 is supplied to the high-pressure-stage turbine 41. Accordingly, the energy of the exhaust gas for the high-pressure-stage turbine 41, in other words, the energy of the force to rotate the turbine generated according to the magnitude of the flow rate or the flow velocity of the exhaust gas is consumed by the high-pressure-stage turbine 41, and thus the energy of the exhaust gas that the low-pressure-stage turbine 51 receives decreases. Therefore, the rotation speed of the low-pressure-stage turbine 51 decreases.

In addition, since the exhaust throttle valve 8 is almost closed as in the first embodiment, the pressure in the outlet-side exhaust passage 35 between the exhaust throttle valve 8 and the low-pressure-stage turbine 51, in other words, the outlet pressure of the low-pressure-stage turbine 51, increases. Thus, the resistance to the exhaust gas discharged from the low-pressure-stage turbine 51 increases, the flow rate and flow velocity of the exhaust gas passing through the low-pressure-stage turbine 51 decrease, and the rotation speed of the low-pressure-stage turbine 51 decreases. When the rotation speed of the low-pressure-stage turbine 51 decreases, the rotation speed of the low-pressure-stage compressor 53 decreases as well, and thus it is possible to avoid a surge occurring in the low-pressure-stage exhaust turbine supercharger 50.

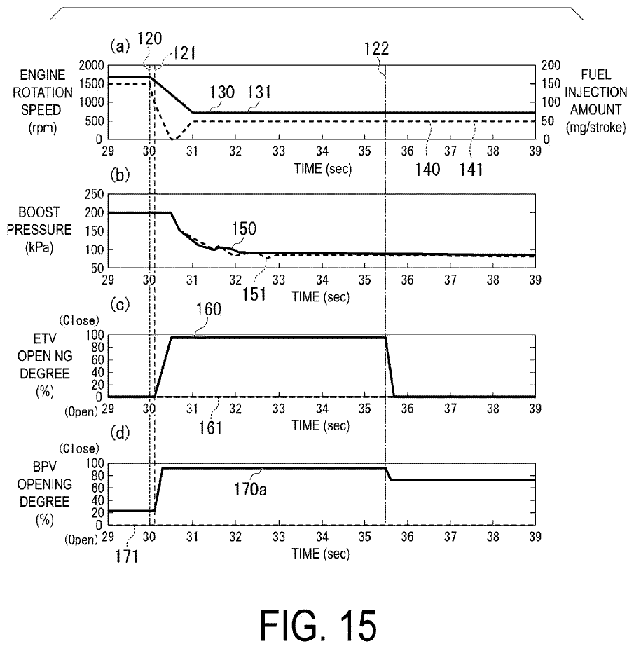

FIG. 15 shows graphs comparing an example of a change when the internal combustion engine system la according to the second embodiment is used with an example of a change when a general internal combustion engine system is used. Here, the general internal combustion engine system is a system in which the surge avoidance control device 10a is removed from the internal combustion engine system la, and the engine controller 3a outputs command values during the normal control time to the bypass valve 7 and the exhaust throttle valve 8.

The units of the vertical axis and the horizontal axis in (a) of FIG. 15 to (d) of FIG. 15 are the same as the units of the vertical axis and the horizontal axis in (a) of FIG. 12 to (d) of FIG. 12, respectively, and the same reference numerals as those given to the graphs in (a) of FIG. 12 to (d) of FIG. 12 are given to the graphs showing the same changes as those in (a) of FIG. 12 to (d) of FIG. 12. The timings indicated by the vertical lines denoted by reference numerals 120, 121, and 122 are also the same as those in the first embodiment, and reference numeral 120 indicates the timing at which deceleration is started, reference numeral 121 indicates the timing at which the control to avoid a surge is started, and reference numeral 122 indicates the timing at which the control to avoid a surge is terminated.

The difference from the first embodiment is a graph showing the change in the opening degree of the bypass valve 7 when the internal combustion engine system la of the second embodiment indicated by reference numeral 170a in (d) of FIG. 15 is applied. In the second embodiment, since the bypass valve control data 114a showing the characteristics shown in FIG. 14 is used, the bypass valve 7 is closed at the timing when control to avoid a surge indicated by reference numeral 121 is started, and when the bypass valve 7 is in the fully closed state, this state is maintained until the timing at which the control to avoid a surge indicated by reference numeral 122 is terminated.

As a result, in (b) of FIG. 15, as indicated by reference numeral 150, the boost pressure when the internal combustion engine system la of the second embodiment is applied changes such that the boost pressure gently decreases and no surge occurs. Therefore, when the internal combustion engine system la of the second embodiment is used, even the internal combustion engine that does not employ the EGR method can avoid surges.

### Other Configuration Examples of Second Embodiment

The second embodiment is on the premise that, since the size of the low-pressure-stage exhaust turbine supercharger 50 is larger than the size of the high-pressure-stage exhaust turbine supercharger 40, a surge is less likely to occur in the high-pressure-stage exhaust turbine supercharger 40 and a surge is more likely to occur in the low-pressure-stage exhaust turbine supercharger 50 in the engine 2a. In contrast, for example, when the high-pressure-stage exhaust turbine supercharger 40 having a size larger than the size of the low-pressure-stage exhaust turbine supercharger 50 is applied, a surge is more likely to occur in the high-pressure-stage exhaust turbine supercharger 40 and is less likely to occur in the low-pressure-stage exhaust turbine supercharger 50 in the engine 2a.

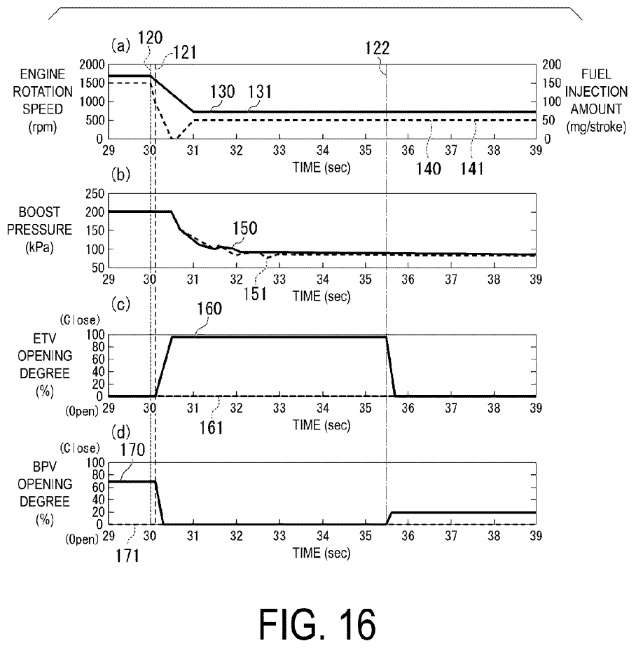

In this case, the bypass valve control data 114 having the characteristics shown in FIG. 6 used in the first embodiment is applied in the storage unit 11a, instead of the bypass valve control data 114a having the characteristics shown in FIG. 14. The internal combustion engine system 1a to which the bypass valve control data 114 is applied shows the changes represented by the graphs of FIG. 16. Note that, since the changes in the graphs shown in FIG. 16 are the same as those in the graphs shown in FIG. 12 of the first embodiment, the same reference numerals as those in FIG. 12 are assigned. In other words, as represented by the graph of reference numeral 170, the bypass valve 7 is open at the timing when control to avoid a surge indicated by reference numeral 121 starts, and when the bypass valve 7 is in a fully open state, this state is maintained until the timing when the control to avoid a surge indicated by reference numeral 122 is terminated.

Accordingly, since most of the exhaust gas discharged from the engine body 5 passes through the bypass valve 7, the amount of the exhaust gas to be supplied to the high-pressure-stage turbine 41 decreases, and the rotation speed of the high-pressure-stage turbine 41 decreases. In addition, when the exhaust throttle valve 8 is substantially closed, the outlet pressure of the high-pressure-stage turbine 41 rises. In other words, the pressure of the exhaust gas present in the portion from the portion of the outlet-side exhaust passage 35 between the exhaust throttle valve 8 and the low-pressure-stage turbine 51 to the connecting exhaust passage 37 via the low-pressure-stage turbine 51 rises. Thus, the resistance to the exhaust gas discharged from the high-pressure-stage turbine 41 increases, the flow rate and flow velocity of the exhaust gas passing through the high-pressure-stage turbine 41 decrease, and the rotation speed of the high-pressure-stage turbine 41 decreases. When the rotation speed of the high-pressure-stage turbine 41 decreases, the rotation speed of the high-pressure-stage compressor 43 decreases as well, and thus it is possible to avoid a surge occurring in the high-pressure-stage exhaust turbine supercharger 40.

Therefore, in the case of the internal combustion engine system la of the second embodiment, by switching the bypass valve control data 114 and 114a stored in the storage unit 11a according to the relationship in size between the high-pressure-stage exhaust turbine supercharger 40 and the low-pressure-stage exhaust turbine supercharger 50, it is possible to select a turbine from the low-pressure-stage turbine 51 and the high-pressure-stage turbine 41, whose rotation speed is to be reduced to avoid surges.

### Third Embodiment

### Overall Configuration of Third Embodiment

An internal combustion engine system 1b according to a third embodiment includes an engine 2b, an engine controller 3b, an accelerator pedal 4, a surge avoidance control device 10b, and a sensor group 20 as illustrated in FIG. 17. Note that, the same components in the third embodiment as those in the first embodiment are denoted by the same reference numerals.

The engine 2b includes an engine body 5, an aftercooler 6, a bypass valve 7, an intake throttle valve (hereinafter, also referred to as an intake throttle valve (ITV)) 9, an exhaust turbine supercharger 40, and passages 31 to 35.

The intake throttle valve 9 is a flow rate regulator that regulates the flow rate of the intake gas passing through an engine-body-side intake passage 32, and is inserted into the engine-body-side intake passage 32. By regulating the opening degree of the intake throttle valve 9, the flow rate of the intake gas passing through the engine-body-side intake passage 32 is regulated, and thus the amount of intake gas taken in by the engine body 5 is regulated.

The engine controller 3b performs feed-forward control and feedback control that are added and removed as the control target is changed from the engine 2 to the engine 2b, in addition to the configuration of the engine controller 3 of the first embodiment. In the engine controller 3b, the control to be added is control over the intake throttle valve 9, and the control to be excluded is control over the exhaust throttle valve 8. In addition, the engine controller 3b does not directly control each of the bypass valve 7 and the intake throttle valve 9 by outputting command values for control, but outputs command values for control over the bypass valve 7 and the intake throttle valve 9 to a flow rate control unit 13a included in a surge avoidance control device 10b.

The surge avoidance control device 10b includes a storage unit 11b, a state transition determination unit 12, and the flow rate control unit 13a. The storage unit 11b stores a data table 110, a surge occurrence precondition table 111, a surge avoidance control start condition table 112, a surge avoidance control termination condition table 113, a bypass valve control data 114, a surge avoidance control flag 116, and a change rate application flag 117, similarly to the storage unit 11 of the first embodiment, and stores intake throttle valve control data instead of the exhaust throttle valve control data 115 having the characteristics shown in FIG. 6. Note that it is assumed here that the characteristics indicated by the intake throttle valve control data are the same as the characteristics indicated by the exhaust throttle valve control data 115. Thus, when a command value for the intake throttle valve 9 (hereinafter also referred to as an ITV command value) has been detected based on the intake throttle valve control data, the command value is a value of about 80% to 95% at any engine rotation speed. Note that the opening degree of the intake throttle valve 9, which is a command value for the intake throttle valve 9, indicates full opening at 0% and full closing at 100%, similarly to the bypass valve 7 and the exhaust throttle valve 8. Furthermore, similarly to the exhaust throttle valve control data 115, the intake throttle valve control data is data in a map control table format in which each of a plurality of different engine rotation speeds and a command value for the intake throttle valve 9 corresponding to each of the engine rotation speeds are associated with each other.

If the state transition determination unit 12 determines that the state has transitioned to a predetermined deceleration state, the flow rate control unit 13a outputs command values to the bypass valve 7 and the intake throttle valve 9 so that the flow rate of the exhaust gas to be supplied to the turbine 41 of the exhaust turbine supercharger 40 becomes a flow rate that reduces the rotation speed of the turbine 41.

### Processing by Surge Avoidance Control Device of Third Embodiment

In the third embodiment, the state transition determination unit 12 performs the processing shown in FIG. 9 of the first embodiment, in which the engine controller 3 is replaced with the engine controller 3b. The flow rate control unit 13a performs the processing shown in FIG. 10 of the first embodiment, in which the flow rate control unit 13 is replaced with the flow rate control unit 13a, the engine controller 3 is replaced with the engine controller 3b, the exhaust throttle valve control data 115 is replaced with the intake throttle valve control data, the ETV command value is replaced with the ITV command value, and the exhaust throttle valve 8 is replaced with the intake throttle valve 9.

### Operation and Effect of Third Embodiment

FIG. 18 is a diagram illustrating a comparison between the effect exhibited when the control to avoid a surge is implemented on the exhaust throttle valve 8 in the internal combustion engine system 1 according to the first embodiment and the effect exhibited when the control to avoid a surge is implemented on the intake throttle valve 9 in the internal combustion engine system 1b according to the third embodiment. (a) of FIG. 18 is a diagram corresponding to the exhaust throttle valve 8, and (b) of FIG. 18 is a diagram corresponding to the intake throttle valve 9. When the control to avoid a surge is started, the exhaust throttle valve 8 is controlled in the closing direction as indicated in (a) of FIG. 18 as described in the first embodiment. The exhaust throttle valve control data 115 and the intake throttle valve control data are data indicating the same characteristics as described above. For this reason, the intake throttle valve 9 is controlled in a closing direction also in the third embodiment as indicated in (b) of FIG. 18.

Accordingly, the outlet pressure of the turbine 41 increases in the first embodiment as described above, Thus, the resistance to the exhaust gas discharged from the turbine 41 increases, the flow rate and flow velocity of the exhaust gas passing through the turbine 41 decrease, and the rotation speed of the turbine 41 decreases. In contrast, in the third embodiment, when the intake throttle valve 9 is substantially closed, the amount of intake gas taken in by the engine body 5 decreases, and thus the amount of exhaust gas discharged from the engine body 5 decreases as well. Thus, the pressure in the turbine-side exhaust passage 33 is reduced. For this reason, the ratio of the pressure of the exhaust gas of the turbine 41 on the inlet side to the pressure of the exhaust gas of the turbine 41 on the outlet side, that is, ‘the pressure of the exhaust gas of the turbine 41 on the inlet side/the pressure of the exhaust gas of the turbine 41 on the outlet side’ becomes low. Therefore, the flow rate and flow velocity of the exhaust gas passing through the turbine 41 decrease, and thereby the rotation speed of the turbine 41 decreases, leading to avoidance of surges as in the case in which the control to avoid a surge is performed on the exhaust throttle valve 8 in the first embodiment.

### Fourth Embodiment

### Overall Configuration of Fourth Embodiment

An internal combustion engine system 1c according to a fourth embodiment includes an engine 2, an engine controller 3c, an accelerator pedal 4, a surge avoidance control device 10c, and a sensor group 20 as illustrated in FIG. 19. Note that, the same components in the fourth embodiment as those in the first embodiment are denoted by the same reference numerals.

The engine controller 3c does not directly control the bypass valve 7 and the exhaust throttle valve 8 by outputting command values for control, but outputs command values for control over each of the valves to a flow rate control unit 13 included in the surge avoidance control device 10c, similarly to the engine controller 3 of the first embodiment. The engine controller 3c does not directly control the engine body 5 by outputting a fuel-injection-amount command value 61 to the engine body 5, but outputs the fuel-injection-amount command value 61 to a fuel-injection-amount control unit 14 included in the surge avoidance control device 10 c.

The surge avoidance control device 10c includes a storage unit 11, a state transition determination unit 12, the flow rate control unit 13, and a fuel-injection-amount control unit 14. The fuel-injection-amount control unit 14 outputs a fuel-injection-amount command value 61a to the engine body 5 so that, if the state transition determination unit 12 determines that the state has transitioned to a predetermined deceleration state, the fuel injection amount of the fuel to be injected into the engine body 5 is equal to or greater than a predetermined amount if the fuel injection amount is less than the predetermined amount. Here, the predetermined amount is, for example, an amount ranging from 50% to 100% of the fuel injection amount in the low idle state.

### Processing by Surge Avoidance Control Device of Fourth Embodiment

In the fourth embodiment, the state transition determination unit 12 performs the processing shown in FIG. 9 of the first embodiment, in which the engine controller 3 is replaced with the engine controller 3c. The flow rate control unit 13 performs the processing shown in FIG. 10 of the first embodiment, in which the engine controller 3 is replaced with the engine controller 3c.

### Processing by Fuel-Injection-Amount Control Unit of Fourth Embodiment

The fuel-injection-amount control unit 14 performs the processing shown in FIG. 20. Note that the processing shown in FIG. 20 is processing performed in parallel with the processing shown in FIGS. 9 and 10. For example, when the power of a construction machine including the internal combustion engine system 1c is turned on, the fuel-injection-amount control unit 14 of the surge avoidance control device 10c is activated and starts the processing of the flowchart of FIG. 20. The fuel-injection-amount control unit 14 waits until there is an output from the engine controller 3c. When the engine controller 3c outputs the fuel-injection-amount command value 61 during the normal control, the fuel-injection-amount control unit 14 accepts the output fuel injection-amount command value 61 (Sc1).

The fuel-injection-amount control unit 14 refers to the flag value of the surge avoidance control flag 116 and determines whether the flag value is ‘ON’ or ‘OFF’ (Sb2). If the fuel-injection-amount control unit 14 determines that the flag value of the surge avoidance control flag 116 is ‘OFF’ (Sb2; OFF), the fuel-injection-amount control unit 14 sets the fuel-injection-amount command value 61 accepted in the processing of Sc1 as an output command value (Sc3), and then performs the processing of Sc6.

On the other hand, if the fuel-injection-amount control unit 14 determines that the flag value of the surge avoidance control flag 116 is ‘ON’ (Sb2; ON), the fuel-injection-amount control unit 14 determines whether the fuel injection amount indicated by the accepted fuel-injection-amount command value 61 is equal to or greater than a predetermined amount (Sc4). If the fuel-injection-amount control unit 14 determines that the fuel injection amount indicated by the accepted fuel-injection-amount command value 61 is equal to or greater than a predetermined amount (Sc4; Yes), the fuel-injection-amount control unit 14 performs the processing of Sc3.

On the other hand, if the fuel injection-amount control unit 14 determines that the fuel injection amount indicated by the accepted fuel-injection-amount command value 61 is not equal to or greater than the predetermined amount (Sc4; No), the fuel injection-amount control unit 14 sets the predetermined amount as an output command value (Sc5), and then performs the processing of Sc6. After the processing of Sc3 and Sc5, the fuel injection-amount control unit 14 outputs the output command value to the engine body 5 as the fuel-injection-amount command value 61a (Sc6), and performs the processing of Sc1 again.

### Operation and Effect of Fourth Embodiment

FIG. 21 is a diagram illustrating the operation of the internal combustion engine system 1c according to the fourth embodiment in a case where the fuel-injection-amount control unit 14 performs the processing shown in FIG. 20 if the state transition determination unit 12 determines that the state has transitioned to the predetermined deceleration state. When the processing shown in FIG. 20 is not performed, the fuel injection amount decreases and reaches ‘0 mg/stroke’ in the vicinity of 30.5 seconds after the timing at which the deceleration indicated by reference numeral 120 begins as shown in the graph of reference numeral 140 in (a) of FIG. 12. In contrast, when the fuel-injection-amount control unit 14 performs the processing shown in FIG. 20, the following occurs. Here, for example, when the predetermined amount is 100% of the amount in the low idle state, the fuel injection amount decreases to ‘50 mg/stroke’ that is the fuel injection amount in the low idle state, and then does not decrease any more.

As a result, the engine body 5 continues to operate, and the engine rotation speed decreases gradually as shown in FIG. 21. More specifically, the slope of the decrease in the change of the engine rotation speed indicated by reference numerals 130 and 131 in (a) of FIG. 12 is gentle between about 30 seconds and about 31 seconds. When the engine body 5 continues to operate, the engine body 5 takes in the intake gas from the engine-body-side intake passage 32. Thus, even if the compressor 43 continues to rotate due to inertia, the pressure of the intake gas present in the engine-body-side intake passage 32 gently increases as well. Therefore, for example, if the operation point of the compressor 43 when the state transition determination unit 12 determines that the state has transitioned to the predetermined deceleration state is the position indicated by reference numeral 500 in FIG. 11, the airflow rate of the compressor 43 gently decreases, and the time required to reach the surge line 400 becomes longer. If the time required to reach the surge line 400 increases, the rotation speed of the compressor 43 due to inertia is correspondingly reduced. Furthermore, the effect of the control to avoid a surge by the flow rate control unit 13 described in the first embodiment is sufficiently exhibited by the increased time required to reach the surge line 400. Therefore, it is possible to avoid surges more reliably in the fourth embodiment than in the first embodiment.

Note that the predetermined amount described above set to an amount from 50% to 100% of the fuel injection amount in the low idle state is merely an example, and any amount may be set as long as the rotation speed of the engine body 5 can follow the rotation due to the inertia of the compressor 43.

### Other Configuration Examples of Each Embodiment

The four types of control to avoid a surge including the control to avoid a surge for the bypass valve 7 shown in the first and second embodiments, the control to avoid a surge for the exhaust throttle valve 8, the control to avoid a surge for the intake throttle valve 9 shown in the third embodiment, and the control to avoid a surge for a fuel injection amount of the engine body 5 shown in the fourth embodiment are all control that exhibits the effect of avoiding surges. Thus, each of the four types of control to avoid a surge may be used independently for the configuration including the single exhaust turbine supercharger 40 shown in the first, third, and fourth embodiments and the configuration including the two exhaust turbine superchargers 40 and 50 shown in the second embodiment. Further, a configuration in which the four types of control to avoid a surge are arbitrarily combined, which is not included in the configuration in which some of the four types of control to avoid a surge shown in the first to fourth embodiments are combined, may be applied to the configuration including one exhaust turbine supercharger 40 shown in the first, third, and fourth embodiments and the configuration including the two exhaust turbine superchargers 40 and 50 shown in the second embodiment.

The numerical values of the conditions shown in the surge occurrence precondition table 111, the surge avoidance control start condition table 112, and the surge avoidance control termination condition table 113 shown in FIGS. 3 to 5 may be changed as appropriate according to the types of construction machines to which the internal combustion engine systems 1, 1a, 1b, and 1c are applied, the environments in which the construction machines are used, and the like.

In the process of the Sb4 in FIG. 9, the preconditions for the occurrence of surge indicated in the surge occurrence precondition table 111 referred to by the state transition determination unit 12 are not limited to the conditions illustrated in FIG. 3, and any conditions may be applied as long as the conditions indicate that the operation point of the compressors 43 is present on the right side of the surge line 400 and the desired engine rotation speed or the desired pressure ratio is achieved.

In the processing of Sb4 in FIG. 9, the start condition for the control to avoid a surge indicated in the surge avoidance control start condition table 112 referred to by the state transition determination unit 12 is not limited to the condition illustrated in FIG. 4, and any condition may be applied as long as the condition indicates that the operation point of the compressors 43 is moving in the direction in which the airflow rate decreases in FIG. 11, for example.

In the processing of Sb5 in FIG. 9, the condition of re-acceleration among the termination conditions for the control to avoid a surge indicated in the surge avoidance control termination condition table 113 referred to by the state transition determination unit 12 is not limited to the condition illustrated in FIG. 5, and any condition may be applied as long as the condition indicates a state of re-acceleration.

The surge avoidance control devices 10, 10a, 10b, and 10c according to the above-described embodiments can be configured using a computer such as a microcomputer or a central processing unit (CPU), and hardware such as peripheral circuits and peripheral devices of the computer. In addition, the surge avoidance control devices 10, 10a, 10b, and 10c include the storage units 11, 11a, and 11b, the state transition determination unit 12, the flow rate control units 13 and 13a, and the fuel-injection-amount control unit 14 as functional configurations configured by a combination of hardware and software such as a program executed by a computer.

Note that the surge avoidance control devices 10, 10a, 10b, and 10c may be configured using a custom large scale integrated circuit (LSI) such as a programmable logic device (PLD). Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

A part or all of the programs executed by the computer in each of the above-described embodiments can be distributed via a computer-readable recording medium or a communication line.

Each of the surge avoidance control devices 10, 10a, 10b, and 10c according to the above embodiments may be provided as one functional unit inside each of the engine controllers 3, 3a, 3b, and 3c corresponding to each of the surge avoidance control devices.

A turbine having a regulation nozzle such as the above-described VGT may be applied instead of the turbine 41, the bypass passage 34, and the bypass valve 7 according to each of the above-described embodiments. In this case, the regulation nozzle provided in the turbine serves as a flow rate regulator.

The engine 2 according to each of the above-described embodiments is, for example, a diesel engine, and the engines 2a and 2b are described on the premise that they are diesel engines; however, the engines 2, 2a, and 2b may be internal combustion engines other than diesel engines.

Although the embodiments of the invention have been described above with reference to the drawings, the specific configuration is not limited to the above-described embodiments and also includes design modifications and the like that do not deviate from the gist of this disclosure.

### INDUSTRIAL APPLICABILITY

According to the surge avoidance control device, the internal combustion engine system, the surge avoidance control method, and the program according to the embodiments of the invention, even an internal combustion engine that does not employ an EGR method can avoid surges.

### REFERENCE SIGNS LIST

1 Internal combustion engine system, 2 Engine (internal combustion engine), 3 Engine controller, 4 Accelerator pedal, 5 Engine body (internal combustion engine body), 6 Aftercooler, 7 Bypass valve, 8 Exhaust throttle valve, 10 Surge avoidance control device, 11 Storage unit, 12 State transition determination unit, 13 Flow rate control unit, 20 Sensor group, 21 Engine rotation speed sensor, 23 Boost pressure sensor, 24 Accelerator opening-degree sensor, 31 Inlet-side intake passage, 32 Engine-body-side intake passage (internal combustion engine body-side passage), 33 Turbine-side exhaust passage, 34 Bypass passage, 35 Outlet-side exhaust passage, 40 Exhaust turbine supercharger, 41 Turbine, 42 Shaft, 43 Compressor, 61 Fuel-injection-amount command value

1. A surge avoidance control device configured to perform control, over an internal combustion engine including an internal combustion engine body and an exhaust turbine supercharger, to avoid a surge that occurs in the exhaust turbine supercharger, the surge avoidance control device comprising:
a state transition determination unit configured to determine whether a state of the internal combustion engine body has transitioned to a predetermined deceleration state in which a surge is estimated to occur in the exhaust turbine supercharger; and
a flow rate control unit configured to control, if the state transition determination unit determines that the state has transitioned to the predetermined deceleration state, a flow rate of an exhaust gas to be supplied to a turbine of the exhaust turbine supercharger to become a flow rate that reduces a rotation speed of the turbine.

2. The surge avoidance control device according to claim 1, wherein
the state transition determination unit
sequentially acquires parameters related to the internal combustion engine body in chronological order, and
determines that the state of the internal combustion engine body has transitioned to the predetermined deceleration state when the parameters from a predetermined time before satisfy a surge occurrence precondition indicating a precondition for an occurrence of the surge and the most recent parameters satisfy a surge avoidance control start condition indicating a start condition for control to avoid the surge.

3. The surge avoidance control device according to claim 2, wherein
the parameters related to the internal combustion engine body include at least one or more of an accelerator opening degree, a fuel injection amount, or a rotation speed of the internal combustion engine body.

4. The surge avoidance control device according to claim 1, wherein
the exhaust turbine supercharger includes
the turbine that is rotated by an exhaust gas discharged from the internal combustion engine body, and
a compressor that is rotated in conjunction with the turbine and compresses an intake gas to be taken into the internal combustion engine body,
the internal combustion engine includes at least one or more of
a flow rate regulator that regulates a flow rate of the exhaust gas to be supplied to the turbine,
a flow rate regulator that regulates a flow rate of the exhaust gas passing through an outlet-side exhaust passage connected to a downstream side of the turbine, or
a flow rate regulator that regulates a flow rate of the intake gas passing through an internal-combustion-engine-side intake passage connected to the internal combustion engine body, and
if the state transition determination unit determines that the state has transitioned to the predetermined deceleration state, the flow rate control unit outputs
a command value for regulating a flow rate to the flow rate regulator such that a flow rate of the exhaust gas to be supplied to the turbine becomes a flow rate that reduces the rotation speed of the turbine.

5. The surge avoidance control device according to claim 4, wherein
the flow rate regulator that regulates the flow rate of the exhaust gas to be supplied to the turbine is a bypass valve that is inserted into a bypass passage that branches off from an internal-combustion-engine-side exhaust passage connecting the internal combustion engine body and the turbine and bypasses the turbine, and
if the state transition determination unit determines that the state has transitioned to the predetermined deceleration state, the flow rate control unit increases
a flow rate of the exhaust gas passing through the bypass passage by outputting the command value for driving the bypass valve in an opening direction to the bypass valve.

6. The surge avoidance control device according to claim 1, wherein
the exhaust turbine supercharger includes
a first exhaust turbine supercharger including a first turbine that is rotated by an exhaust gas discharged from the internal combustion engine body and a first compressor that is rotated in conjunction with the first turbine and compresses an intake gas to be taken into the internal combustion engine body, and
a second exhaust turbine supercharger including a second turbine that is rotated by an exhaust gas discharged from the first turbine and a second compressor that is rotated in conjunction with the second turbine and supplies the intake gas that is compressed to the first compressor,
the internal combustion engine includes at least one or more of
a flow rate regulator that regulates a flow rate of the exhaust gas to be supplied to the first turbine,
a flow rate regulator that regulates a flow rate of the exhaust gas passing through an outlet-side exhaust passage connected to a downstream side of the second turbine, or
a flow rate regulator that regulates a flow rate of the intake gas passing through an internal-combustion-engine-side intake passage connected to the internal combustion engine body, and
if the state transition determination unit determines that the state has transitioned to the predetermined deceleration state, the flow rate control unit outputs
a command value for regulating a flow rate to the flow rate regulator such that a flow rate of the exhaust gas to be supplied to one of the first turbine and the second turbine becomes a flow rate that reduces the rotation speed of the one of the first turbine and the second turbine.

7. The surge avoidance control device according to claim 6, wherein
the flow rate regulator that regulates the flow rate of the exhaust gas to be supplied to the first turbine is a bypass valve that is inserted into a bypass passage that branches off from an internal-combustion-engine-side exhaust passage connecting the internal combustion engine body and the first turbine and bypasses the first turbine, and
if the state transition determination unit determines that the state has transitioned to the predetermined deceleration state, the flow rate control unit
increases a flow rate of the exhaust gas passing through the bypass passage by outputting the command value for driving the bypass valve in an opening direction to the bypass valve if the surge is known to occur in the first turbine, and
reduces a flow rate of the exhaust gas passing through the bypass passage by outputting the command value for driving the bypass valve in a closing direction to the bypass valve if the surge is known to occur in the second turbine.

8. The surge avoidance control device according to claim 4, wherein
the flow rate regulator that regulates the flow rate of the exhaust gas passing through the outlet-side exhaust passage is an exhaust throttle valve that is inserted into the outlet-side exhaust passage, and
if the state transition determination unit determines that the state has transitioned to the predetermined deceleration state, the flow rate control unit reduces
a flow rate of the exhaust gas passing through the outlet-side exhaust passage by outputting the command value for driving the exhaust throttle valve in a closing direction to the exhaust throttle valve.

9. The surge avoidance control device according to claim 4, wherein
the flow rate regulator that regulates the flow rate of the intake gas passing through the internal-combustion-engine-side intake passage is an intake throttle valve that is inserted into the internal-combustion-engine-side intake passage, and
if the state transition determination unit determines that the state has transitioned to the predetermined deceleration state, the flow rate control unit reduces
a flow rate of the intake gas passing through the internal-combustion-engine-side intake passage by outputting the command value for driving the intake throttle valve in a closing direction to the intake throttle valve.

10. The surge avoidance control device according to claim 1, further comprising
a fuel-injection-amount control unit configured to regulate, if the state transition determination unit determines that the state has transitioned to the predetermined deceleration state, a fuel injection amount of a fuel to be injected into the internal combustion engine body such that the fuel injection amount becomes equal to or greater than a predetermined amount if the fuel injection amount is less than the predetermined amount.

11. The surge avoidance control device according to claim 1, wherein
the state transition determination unit determines
whether a surge avoidance control termination condition indicating a termination condition for control to avoid the surge is satisfied, after determining that the state has transitioned to the predetermined deceleration state, and
if the state transition determination unit determines that the surge avoidance control termination condition is satisfied, the flow rate control unit switches
the control on a flow rate of the exhaust gas to be supplied to the turbine of the exhaust turbine supercharger to normal control.

12. The surge avoidance control device according to claim 11, wherein the surge avoidance control termination condition is a condition indicating whether re-acceleration has been performed.

13. The surge avoidance control device according to claim 11, wherein
the surge avoidance control termination condition is a condition indicating whether a predetermined surge avoidance control time has elapsed, and
if the state transition determination unit determines that the predetermined surge avoidance control time has elapsed and the surge avoidance control termination condition is satisfied, after determining that the state has transitioned to the predetermined deceleration state, the flow rate control unit applies, to control of a flow rate of the exhaust gas to be supplied to the turbine of the exhaust turbine supercharger, a command value obtained by changing, so that a command value used immediately before for controlling a flow rate of the exhaust gas to be supplied to the turbine of the exhaust turbine supercharger approaches a command value when the normal control is performed, the command value used immediately before at a predetermined change rate.

14. A surge avoidance control device configured to perform control, over an internal combustion engine including an internal combustion engine body and an exhaust turbine supercharger, to avoid a surge that occurs in the exhaust turbine supercharger, the surge avoidance control device comprising:
a state transition determination unit configured to determine whether a state of the internal combustion engine body has transitioned to a predetermined deceleration state in which a surge is estimated to occur in the exhaust turbine supercharger; and
a fuel-injection-amount control unit configured to regulate, if the state transition determination unit determines that the state has transitioned to the predetermined deceleration state, a fuel injection amount of a fuel to be injected into the internal combustion engine body such that the fuel injection amount becomes equal to or greater than a predetermined amount if the fuel injection amount is less than the predetermined amount.

15. An internal combustion engine system comprising:
an internal combustion engine including an internal combustion engine body and an exhaust turbine supercharger; and
a surge avoidance control device configured to perform control to avoid a surge that occurs in the exhaust turbine supercharger, wherein
the surge avoidance control device includes
a state transition determination unit that determines whether a state of the internal combustion engine body has transitioned to a predetermined deceleration state in which a surge is estimated to occur in the exhaust turbine supercharger, and
a flow rate control unit that controls, if the state transition determination unit determines that the state has transitioned to the predetermined deceleration state, a flow rate of an exhaust gas to be supplied to a turbine of the exhaust turbine supercharger to become a flow rate that reduces a rotation speed of the turbine.

16. (canceled)

17. (canceled)
